(19) United States
(12) Patent Application Publication
(10) Pub. No.: US 2008/0068522 A1
(43) Pub. Date: Mar. 20, 2008

(54) DISPLAY DEVICE AND A METHOD OF MANUFACTURING THE SAME

(75) Inventor: Yukiko Irie, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/853,455

(22) Filed: Sep. 11, 2007

(30) Foreign Application Priority Data
Sep. 13, 2006 (JP) 2006-247862

(51) Int. Cl. G02F 1/141

(52) U.S. Cl. 349/37

(57) ABSTRACT

Disclosed herein is a display device, including, a pixel electrode, a pixel switching element, a holding capacitor element, a pixel electrode relay portion and a signal wiring.

### CROSS REFERENCES TO RELATED APPLICATIONS

The present invention contains subject matter related to Japanese Patent Application JP 2006-247862 filed in the Japan Patent Office on Sep. 13, 2006, the entire contents of which being incorporated herein by reference.

### BACKGROUND OF THE INVENTION

1. Field of the Invention

The present invention relates to a display device and a method of manufacturing the same. More particularly, the invention relates to a display device for displaying an image on a screen by inversely driving a plurality of pixels in a pixel region having a plurality of pixels formed on a substrate.

2. Description of the Related Art

Display devices such as a liquid crystal display device and an organic EL display device have advantages such as slimness, lightness in weight and low power consumption as compared with a cathode ray tube (CRT). Thus, such display devices are used as ones for use in electronic apparatuses such as a personal computer, a mobile phone, and a digital camera.

A liquid crystal display device has a liquid crystal panel in which a liquid crystal layer is enclosed into a space defined between a pair of substrates. The liquid crystal panel transmits and modulates a light radiated from a flat surface light source such as a back light provided in a back surface of the liquid crystal panel. Also, display of an image is made in the front of the liquid crystal panel by using the modulated light. A liquid crystal panel utilizing an active matrix system, for example, is known as such a liquid crystal panel.

FIG. 19 is a circuit diagram showing a circuit structure of a liquid crystal panel 100 utilizing the active matrix system in a liquid crystal display device. FIG. 20 is a plan view showing a part of the liquid crystal panel 100 utilizing the active matrix system. FIG. 21 is a cross sectional view showing a part of the liquid crystal panel 100 utilizing the active matrix system. Each of FIGS. 20 and 21 shows a portion a surrounded by a dashed line in FIG. 19. Also, FIG. 21 showing portions from an array substrate 11 to an interlayer insulating film 17 is taken on line A1-A2 of FIG. 20.

As shown in FIG. 21, the liquid crystal panel 100 includes an array substrate 11, a counter substrate 21, and a liquid crystal layer 31.

The array substrate 11, as shown in FIG. 21, is a substrate which, for example, is made of an insulator such as a glass which transmits a light. Also, pixel electrodes 101, pixel switching elements 102, holding capacitor elements 103, scanning wirings 201, signal wirings 202, holding capacitor wirings 203, a gate driver 301, and a source driver 302 of members shown in FIG. 19 are formed on the array substrate 11. In this case, as shown in FIG. 19, the pixel electrodes 101, the pixel switching elements 102, the holding capacitor elements 103, the scanning wirings 201, signal wirings 202, and the holding capacitor wirings 203 are formed in a pixel region PR of the crystal panel 100. Also, the gate driver 301 and the source driver 302 are formed in a peripheral region of the pixel region PR.

The counter substrate 21, as shown in FIG. 21, is a substrate which, for example, is made of an insulator such as a glass which transmits a light similarly to the case of the array substrate 11. Also, one surface of the counter substrate 21 faces the array substrate 11. A counter electrode 23 is formed as a transparent electrode made of an indium tin oxide (ITO) or the like on a surface on a surface of the counter electrode 23 facing the array substrate 11 so as to face the pixel electrode 101.

A liquid crystal layer 31, as shown in FIG. 21, is enclosed into a space defined between the array substrate 11 and the counter substrate 21, and orientation processing is performed for the liquid crystal layer 31. Also, the liquid crystal layer 31, as shown in FIG. 19, is connected to each of the pixel electrode 101 and the counter electrode 23. Thus, an orientation state of the liquid crystal layer 31 changes in accordance with a voltage applied across the pixel electrode 101 and the counter electrode 23, so that an image is displayed on a screen.

When the liquid crystal panel 100 utilizing such an active matrix system is driven, the gate driver 301 successively supplies a scanning signal to scanning wirings 201 disposed in a y direction in a time division manner, thereby turning ON the pixel switching elements 102 in order. Also, the source driver 302 supplies a data signal to the signal wirings 202 in correspondence to timings at which the scanning signal is successively supplied to the scanning wirings. Thus, the data signal is applied to the pixel electrode 101 through the pixel switching element 102 held in an ON state. As a result, a suitable voltage is applied across the liquid crystal layer 31, so that optical characteristics of the liquid crystal layer 31 change, thereby displaying an image on a screen. This sort of technique, for example, is described in Japanese Patent Laid-Open Nos. 2005-223027, 2004-245872, 2001-144298 and 2003-131589.

In the liquid crystal panel 100 described above, as shown in FIGS. 20 and 21, the pixel switching element 102 and the holding capacitor elements 103 are formed on a surface of the array substrate 11 so as to face the region in which the conductive layers such as the signal wiring 202 are formed. That is to say, the pixel switching element 102 and the holding capacitor elements 103 are formed so as to overlap the conductive layers such as the signal wirings 202, a holding capacitor element relay portions 401, and a pixel electrode relay portion 402 in a direction z vertical to the array substrate 11 through an interlayer insulating film 16. This results in that an aperture ratio of the pixel region PR is improved to enhance a light transmittance, thereby enhancing an image quality.

### SUMMARY OF THE INVENTION

When the liquid crystal panel 100 is driven, in order to prevent the liquid crystal layer 31 from being deteriorated due to application of a D.C. voltage, the driving is performed in accordance with an inversely driving system. The inversely driving system is a driving system for alternately inversing a direction of an electric field applied to the liquid crystal layer 31. For example, the inversely driving system means that an A.C. data signal is applied to the liquid crystal layer 31, thereby alternately inversing a polarity of a potential given to the pixel electrode 101 with respect to a potential of the counter electrode 23. That is to say, the inversely driving system means that a high potential and a low potential are alternately written to the pixel electrode 101.

FIG. 22 is a waveform chart when the liquid crystal panel 100 is inversely driven. In FIG. 22, a line L1 indicates a potential of the pixel electrode 101, a line L2 indicates a waveform of a data signal applied from the signal wiring 202 to the pixel switching element, and a line L3 indicates a reference potential.

In addition, FIGS. 23A and 23B are respectively views showing potentials which are held in the respective portions of the liquid crystal panel 100 after a gate is turned OFF when the liquid crystal panel 100 is inversely driven. That is to say, FIG. 23A shows the case where a high potential HIGH is written to the pixel electrode 101. Also, FIG. 23B shows the case where a low potential LOW is written to the pixel electrode 101.

When the liquid crystal panel 100 is inversely driven, a gate-ON voltage is applied as a scanning signal to a gate electrode 102g of a pixel switching element 102 through a scanning wiring 201 to turn ON the pixel switching element 102. Also, as indicated by the line L2 in FIG. 22, a data signal at a high potential HIGH which is positive with respect to the reference potential L3 is applied through the signal wiring 202. The data signal at the high potential HIGH is applied to the pixel electrode 101 through the pixel switching element 102. Also, after the pixel switching element 102 is held in the ON state for a predetermined time period, a gate-OFF voltage is applied to the gate electrode 102g of the pixel switching element 102 through the scanning line 201, thereby turning OFF the pixel switching element 102. As a result, supplying the data signal at the high potential HIGH through the signal wiring 202 is completed.

At this time, as indicated by the line L1 in FIG. 22, the pixel electrode 101 becomes a state in which the high potential HIGH is written thereto. Also, as shown in FIG. 23A, the signal wiring 202 is at the low potential LOW. A source/drain region 102a, of a pair of source/drain regions 102a and 102b of the switching element 102, which is connected to the signal wiring 202 becomes the low potential LOW similarly to the case of the signal wiring 202. On the other hand, the source/drain region 102b connected to the pixel electrode 101 becomes the high potential HIGH similarly to the case of the pixel electrode 101. Also, as shown in FIG. 22, even after the OFF state, the pixel electrode 101 holds a display voltage based on the potential holding property of the liquid crystal layer 31 and the holding capacitor element 103. However, an OFF current is leaked, so that the potential changes.

After that, the gate-ON voltage is applied to the gate electrode of the pixel switching element 102 again to turn ON the pixel switching element 102. Also, as indicated by the line L2 in FIG. 22, applying the data signal at the low potential LOW which is negative with respect to the reference potential L3 follows the application of the high potential HIGH described above.

At this time, as indicated by the line L1 in FIG. 22, the pixel electrode 101 becomes the state in which the low potential LOW is written thereto. Also, as shown in FIG. 23B, the signal wiring 202 is at the high potential HIGH, so that the source/drain region 102a, of a pair of source/drain regions 102a and 102b of the pixel switching element 102, which is connected to the signal wiring 202 becomes the high potential HIGH similarly to the case of the signal wiring 202. On the other hand, the source/drain region 102b connected to the pixel electrode 101 becomes the low potential LOW similarly to the case of the pixel electrode 101. Also, similarly to the foregoing, as shown in FIG. 22, even after the OFF state, the pixel electrode 101 holds a display voltage based on the potential holding property of the liquid crystal layer 31 and the holding capacitor element 103. However, an OFF current is leaked, so that the potential changes.

When the inverse driving is performed by using the high potential HIGH and the low potential LOW in such a manner, the potential difference held by the pixel electrode 101 changes due to the OFF current. For this reason, the image information comes not to be sufficiently held, so that the image quality is reduced in some cases.

In addition, in this case, as shown in FIG. 22, a magnitude of the leakage current in the phase of the OFF state is different between a time point after the driving at the high potential HIGH and a time point after the driving at the low potential LOW. Thus, the magnitude of the OFF current may become larger in the time point after the driving at the high potential HIGH than in the time point after the driving at the low potential LOW. For this reason, a held potential VH in the phase of application of the high potential HIGH and a held potential VL in the phase of application of the low potential LOW are different from each other in the pixel electrode 101 after a lapse of a predetermined time. Thus, when the inverse driving is performed, the display differs between the case of the high potential HIGH and the case of the low potential LOW. As a result, a flicker and a residual image may occur to reduce the image quality.

In order to suppress such nonconformity, a lightly doped drain (LDD) structure is adopted in the pixel switching element 102. In a TFT having this LDD structure, a concentration of an electric field on a drain edge is relaxed by a low concentration impurity diffusion region having a high electrical resistance value to reduce the OFF current, thereby enhancing the image quality.

However, in the case where as shown in FIGS. 20 and 21, each of the pixel switching element 102 and the holding capacitor element 103 is formed on a surface of the array substrate 11 so as to correspond to the region having the conductive layers such as the signal wirings 202 formed therein in order to enhance the aperture ratio of the pixel region, as described above, the magnitude of the OFF current may remarkably differ between the driving using the high potential HIGH and the driving using the low potential LOW.

More specifically, as shown in FIG. 23A, while the pixel electrode 101 holds the high potential HIGH, the source/drain region 102b, of a pair of source/drain regions 102a and 102b of the pixel switching element 102, which is connected to the pixel electrode 101 is held at the high potential HIGH. On the other hand, the signal wiring 202 facing the source/drain region 102b through the interlayer insulating film 16 is held at the low potential LOW. As a result, a potential difference occurs between the source/drain region 102b and the signal wiring 202, so that the frequency of occurrence of the leakage current in the phase of the OFF state becomes high.

On the other hand, as shown in FIG. 23B, while the pixel electrode 101 holds the low potential LOW, the source/drain region 102a, of a pair of source/drain regions 102a and 102b of the pixel switching element 102, which is connected to the signal wiring 202 is held at the high potential HIGH. On the other hand, the signal wiring 202 facing the source/drain region 102a through the interlayer insulating film 16 is also held at the high potential HIGH. As a result, no potential difference occurs between them, so that the frequency of occurrence of the leakage current in the phase of the OFF state becomes low.

For this reason, when each of the pixel switching element 102 and the holding capacitor element 103 is formed on the surface of the array substrate 11 so as to face the region having the signal wiring 202 formed therein, the flicker and the residual image may occur, so that the nonconformity may be actualized in which the image quality is reduced.

This phenomenon is also applied to the case where the pixel switching element 102 is formed so as to face the holding capacitor element 103 as well as to the case where the pixel switching element 102 is formed so as to face the conductive layer such as the signal wiring 202 in the manner as described above.

FIGS. 24A and 24B are respectively views each schematically showing the potentials held in the respective portions of the liquid crystal panel 100. Here, the potentials are held in the respective portions of the liquid crystal panel 100 after the gate is turned OFF when the liquid crystal panel 100 is inversely driven in the case where the pixel switching element 102 is formed so as to face the holding capacitor element 103. That is to say, FIG. 24A shows the case where the high potential is written to the pixel electrode, and FIG. 24B shows the case where the low potential is written to the pixel electrode.

As shown in FIG. 24A, while the pixel electrode 101 holds the high potential HIGH, the source/drain region 102b, of a pair of source/drain regions 102a and 102b of the pixel switching element 102, which is connected to the pixel electrode 101 side is held at the high potential HIGH. On the other hand, a lower electrode 103b of the holding capacitor element 103 facing the source/drain region 102b through the interlayer insulating film 16 is held at the high potential HIGH. For this reason, no potential difference occurs between a portion of the source/drain region 102b, and a portion of the lower electrode 103b of the holding capacitor element 103 which face each other through the interlayer insulating film 16. As a result, the frequency of occurrence of the leakage current in the phase of the OFF state becomes low.

On the other hand, as shown in FIG. 24B, while the pixel electrode 101 holds the low potential LOW, the source/drain region 102a, of a pair of source/drain regions 102a and 102b of the pixel switching element 102, which is connected to the signal wiring 202 side is held at the high potential HIGH. On the other hand, the lower electrode 103b of the holding capacitor element 103 facing the source/drain region 102a through the interlayer insulating film 16 is held at the low potential LOW. For this reason, the potential difference occurs between them, so that the frequency of occurrence of the leakage current in the phase of the OFF state becomes high.

As described above, when the potential of the drain side of a pair of source/drain regions 102a and 102b of the pixel switching element 102 in the phase of the driving, and the potential of the conductive layer, such as the signal wiring 202 or the lower electrode 103b, facing the drain side through the interlayer insulating film 16 are different from each other, the nonconformity as described above may occur.

FIG. 25 is a graphical representation showing a relationship between a resolution of the liquid crystal panel, and a leakage luminescent spot percent defective.

The leakage luminescent spot percent defective (%) increases along with an increase in resolution of the liquid crystal panel as shown in FIG. 25. Thus, the image quality may be reduced due to this main cause.

As described above, when the pixel switching element 102 is formed on the surface of the array substrate 11 so as to face the conductive layers such as the signal wiring 202 and the lower electrode 103b of the holding capacitor element 103 in order to enhance the aperture ratio of the pixel region, or when the resolution is improved, the leakage current in the phase of the OFF state increases. As a result, the image holding characteristics are remarkably reduced, and the flicker and the residual image become easy to occur in the phase of the inverse driving. Thus, the nonconformity may be actualized in which the image quality is reduced.

In the light of the foregoing, it is desirable to provide a display device which is capable of enhancing an image quality, and a method of manufacturing the same.

According to an embodiment of the present invention, there is provided a display device, including:

a pixel electrode;

a pixel switching element having a first source/drain region and a second source/drain region formed to hold a channel formation region between them, and a gate electrode provided to correspond to the channel formation region through a gate insulating film;

a holding capacitor element having a first electrode and a second electrode formed to sandwich a dielectric film between them, the second electrode being connected to the second source/drain region;

a pixel electrode relay portion made of a conductive material, the pixel electrode and the second source/drain region being connected to each other through the pixel electrode relay portion; and

a signal wiring connected to the first source/drain region;

in which the holding capacitor element is formed so that the dielectric film and the gate insulating film constitute the same layer, and the second electrode and the second source/drain region constitute the same layer;

the signal wiring extends at a predetermined interval from the first source/drain region so as to face each of the first source/drain region, the gate electrode and the second source/drain region;

the pixel electrode relay portion extends from the second source/drain region so as to face each of the gate electrode and the holding capacitor element between the signal wiring and each of the gate electrode and the second source/drain region; and

when a pixel potential is held through inverse driving, the signal wiring and the second source/drain region become different in potential from each other, and the pixel potential relay portion and the second source/drain region become equal in potential to each other.

According to another embodiment of the present invention, there is provided a display device, including:

a pixel switching element having a first source/drain region and a second source/drain region formed to hold a channel formation region between them, and a gate electrode formed to correspond to the channel formation region through a gate insulating film;

a holding capacitor element having a first electrode and a second electrode formed to sandwich a dielectric film between them, the second electrode being connected to the second source/drain region;

a signal wiring connected to the first source/drain region; and

a signal wiring relay portion made of a conductive material, the signal wiring and the first source/drain region being connected to each other through the signal wiring relay portion;

in which the signal wiring extends at a predetermined interval from each of the gate electrode and the second source/drain region so as to face each of them;

the signal wiring relay portion extends from the first source/drain region to the gate electrode between the first source/drain region and the signal wiring;

the second electrode extends from the second source/drain region so as to face each of the second source/drain region and the first source/drain region through the signal wiring relay portion between the signal wiring and the signal wiring relay portion; and

when a pixel potential is held through inverse driving, the signal wiring and the second source/drain region becomes different in potential from each other, the second electrode and the first source/drain region becomes different in potential from each other, and the signal wiring relay portion and the first source/drain region become equal in potential to each other.

According to each of the embodiments of the present invention, it is possible to provide the display device which is capable of enhancing an image quality, and a method of manufacturing the same.

### BRIEF DESCRIPTION OF THE DRAWINGS

FIG. 1 is a cross sectional view showing a structure of a liquid crystal panel in a liquid crystal display device according to a first embodiment of the present invention;

FIG. 2 is a circuit diagram showing a circuit structure of the liquid crystal panel in the liquid crystal display device according to the first embodiment of the present invention;

FIG. 3 is a plan view showing a part of the liquid crystal panel in the liquid crystal display device according to the first embodiment of the present invention;

FIG. 4 is a cross sectional view showing a part of the liquid crystal panel in the liquid crystal display device according to the first embodiment of the present invention;

FIGS. 5A to 5E are respectively cross sectional views showing processes for an array substrate side in the liquid crystal display device according to the first embodiment of the present invention;

FIGS. 6A and 6B are respectively views schematically showing potentials which are held in respective portions of the liquid crystal panel after a gate is turned OFF when the liquid crystal panel is inversely driven in the liquid crystal display according to the first embodiment of the present invention;

FIG. 7 is a plan view showing a part of a liquid crystal panel in a liquid crystal display device according to a second embodiment of the present invention;

FIG. 8 is a cross sectional view showing a part of the liquid crystal panel in the liquid crystal display device according to the second embodiment of the present invention;

FIGS. 9A to 9C are respectively cross sectional views showing processes for an array substrate side in the liquid crystal display device according to the second embodiment of the present invention;

FIG. 10 is a plan view showing a part of a liquid crystal panel in a liquid crystal display device according to a third embodiment of the present invention;

FIG. 11 is a cross sectional view showing a part of the liquid crystal panel in the liquid crystal display device according to the third embodiment of the present invention;

FIGS. 12A to 12E are respectively cross sectional views showing processes for an array substrate side in the liquid crystal display device according to the third embodiment of the present invention;

FIGS. 13A and 13B are respectively views schematically showing potentials which are held in respective portions of the liquid crystal panel after a gate is turned OFF when the liquid crystal panel is inversely driven in the liquid crystal display according to the third embodiment of the present invention;

FIG. 14 is a plan view showing a part of a liquid crystal panel in a liquid crystal display device according to a fourth embodiment of the present invention;

FIG. 15 is a cross sectional view showing a part of the liquid crystal panel in the liquid crystal display device according to the fourth embodiment of the present invention;

FIGS. 16A and 16B are respectively cross sectional views showing processes for an array substrate side in the liquid crystal display device according to the fourth embodiment of the present invention;

FIGS. 17A and 17B are respectively views schematically showing potentials which are held in respective portions of the liquid crystal panel after a gate is turned OFF when the liquid crystal panel is inversely driven in the liquid crystal display according to the fourth embodiment of the present invention;

FIG. 18 is a plan view showing a part of a liquid crystal panel in a liquid crystal display device according to a fifth embodiment of the present invention;

FIG. 19 is a circuit diagram showing a circuit structure of a liquid crystal panel of a liquid crystal display device utilizing an active matrix system in the related art;

FIG. 20 is a plan view showing a part of the liquid crystal panel of the liquid crystal display device utilizing the active matrix system in the related art;

FIG. 21 is a cross sectional view showing a part of the liquid crystal panel of the liquid crystal display device utilizing the active matrix system in the related art;

FIG. 22 is a waveform chart when the liquid crystal panel is inversely driven;

FIGS. 23A and 23B are respectively views schematically showing potentials which are held in respective portions of the liquid crystal panel after a gate is turned OFF when the liquid crystal panel is inversely driven in the liquid crystal display in the related art;

FIGS. 24A and 24B are respectively views each schematically showing potentials which are held in respective portions of the liquid crystal panel after the gate is turned OFF when the liquid crystal panel is inversely driven in the case where a pixel switching element is formed so as to face a holding capacitor element; and

FIG. 25 is a graphical representation showing a relationship between a resolution of the liquid crystal panel and a leakage luminescent spot percent defective.

### DETAILED DESCRIPTION OF THE PREFERRED EMBODIMENTS

Preferred embodiments of the present invention will be described in detail hereinafter with reference to the accompanying drawings.

### First Embodiment

(Structure)

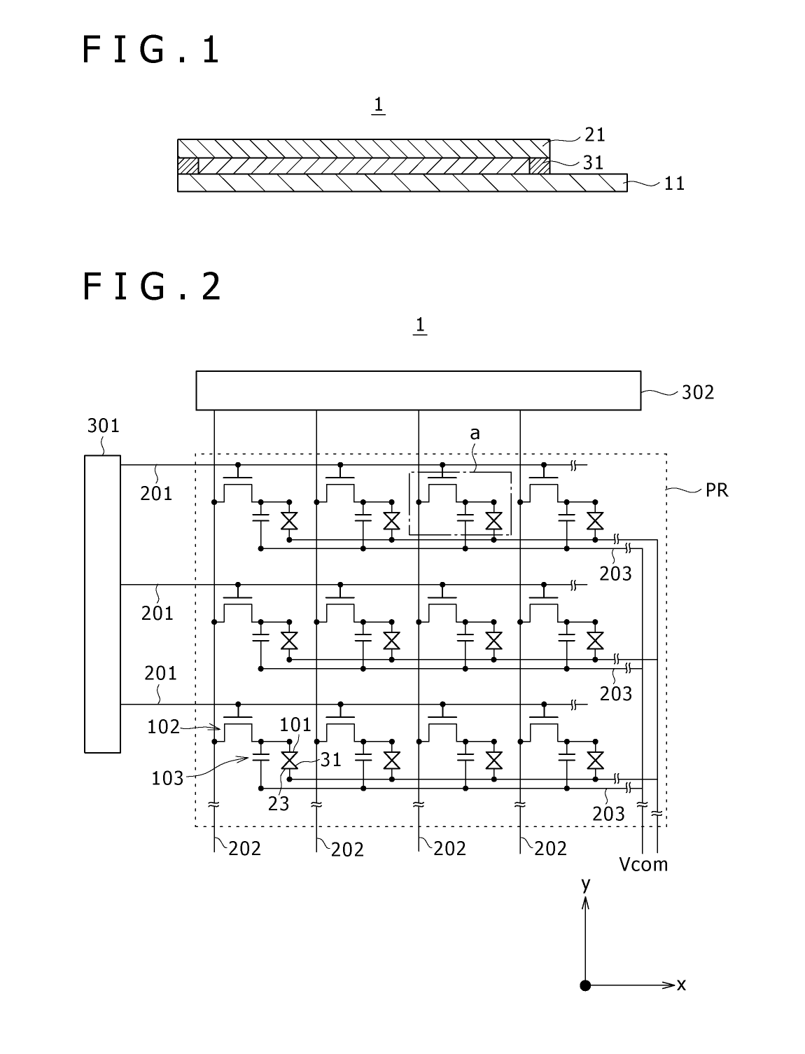

FIGS. 1, 2, 3 and 4 are respectively views each showing a liquid crystal panel 1 of a liquid crystal display device according to a first embodiment of the present invention.

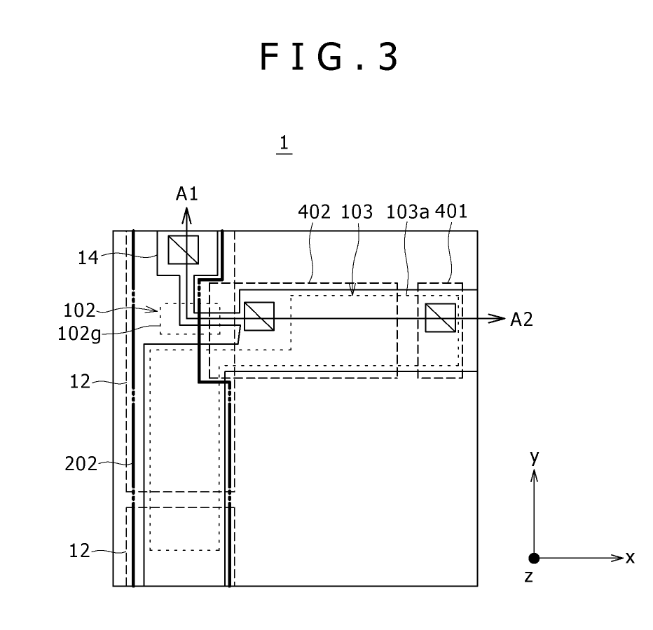

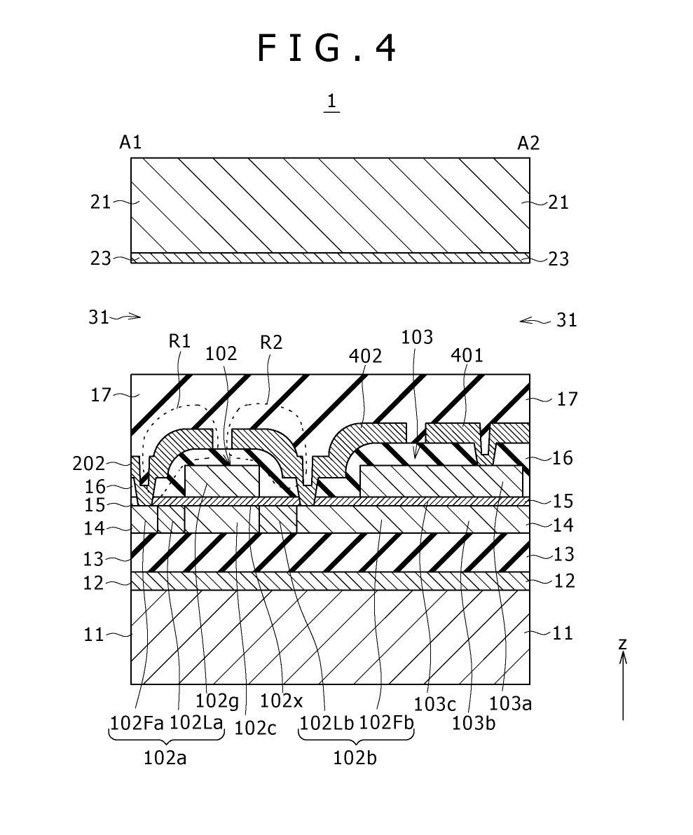

FIG. 1 is a cross sectional view showing a structure of the liquid crystal panel 1 in the liquid crystal display device according to the first embodiment of the present invention. FIG. 2 is a circuit diagram showing a circuit structure of the liquid crystal panel 1 in the liquid crystal display device according to the first embodiment of the present invention. In addition, FIG. 3 is a plan view showing a part of the liquid crystal panel 1 in the liquid crystal display device according to the first embodiment of the present invention. Also, FIG. 3 shows a portion a surrounded by a dashed line in FIG. 2. Also, FIG. 4 is a cross sectional view showing a part of the liquid crystal panel 1 in the liquid crystal display device according to the first embodiment of the present invention. FIG. 4 showing portions from an array substrate 11 to an interlayer insulating film 17 is taken on line A1-A2 of FIG. 3.

As shown in FIG. 1, the liquid crystal panel 1 includes the array substrate 11, a counter substrate 21, and a liquid crystal layer 31. In addition, as shown in FIG. 2, the liquid crystal panel 1 also includes counter electrodes 23, pixel electrodes 101, pixel switching elements 102, holding capacitor elements 103, scanning wirings 201, signal wirings 202, holding capacitor wirings 203, a gate driver 301, and a source driver 302 in addition to the portions described above. That is to say, the liquid crystal panel 1 of the liquid crystal display device of this embodiment utilizes the active matrix system. The portions of the liquid crystal panel 1 will now be described in order.

The array substrate 11, as shown in FIG. 1, is a substrate which, for example, is made of an insulator such as glass which transmits a light. The pixel electrodes 101, the pixel switching elements 102, the holding capacitor elements 103, the scanning wirings 201, the signal wirings 202, the holding capacitor wirings 203, the gate driver 301, and the source driver 302 are formed on the array substrate 11 made of the insulating material shown in FIG. 2. In this case, as shown in FIG. 2, the pixel electrodes 101, the pixel switching elements 102, the holding capacitor elements 103, the scanning wirings 201, the signal wirings 202, and the holding capacitor wirings 203 are formed within a pixel region PR of the liquid crystal panel 1. Also, the gate driver 301 and the source driver 302 are formed in a peripheral region of the pixel region PR.

The counter substrate 21, as shown in FIG. 1, is a substrate, is made of an insulator such as a glass which transmits a light similarly to the case of the array substrate 11. As shown in FIG. 1, one surface of the counter substrate 21 face the array substrate 11 so as to be kept apart from the array substrate 11. Also, the counter substrate 21 is stuck to the array substrate 11 in the periphery of the pixel region PR with a sealing material. Also, as shown in FIG. 4, the counter electrode 21 is formed as a transparent electrode made of an indium tin oxide (ITO) or the like so as to face the array substrate 11. In this case, the counter electrode 23 is formed as a common electrode corresponding to a plurality of pixel electrodes 101 so as to cover all over the surface of the pixel region PR.

As shown in FIG. 1, for the liquid crystal layer 31, for example, a twisted nematic type liquid crystal is injected into a space defined between the array substrate 11 and the counter substrate 21, and the orientation processing is then performed for the twisted nematic type liquid crystal. Also, as shown in FIG. 2, the liquid crystal layer 31 is connected to each of the pixel electrode 101 and the counter electrode 23. Thus, an orientation state of the liquid crystal layer 31 changes in accordance with the voltage applied across the pixel electrode 101 and the counter electrode 23, thereby displaying an image.

The portions formed on the array substrate 11 will now be described.

The pixel electrode 101 is the transparent electrode made of the conductive material such as the ITO. Thus, as shown in FIG. 2, a plurality of pixel electrodes 101 are disposed in matrix so as to be arranged in an x direction and in a y direction, and are connected to the liquid crystal layer 31. In this case, the pixel electrodes 101 are formed so as to correspond to regions formed through division with a plurality of scanning wirings 201 extending in the y direction so as to be kept apart from one another, and a plurality of signal wirings 202 extending in the x direction so as to be kept apart from one another.

As shown in FIG. 2, a plurality of pixel switching elements 102 are disposed in matrix in the x direction and in the y direction so as to correspond to a plurality of pixel electrodes 101, respectively, in the pixel region PR. Also, a plurality of pixel switching elements 102 are connected to the pixel electrodes 101, respectively. Also, as shown in FIG. 4, the pixel switching element 102 is formed on the surface side of the array substrate 11 facing the counter substrate 21 through a light shielding film 12 and the interlayer insulating film 13. Also, as shown in FIG. 4, the pixel switching element 102 is formed on the surface side of the array substrate 11 so as to correspond to the region in which the signal wiring 202 is formed. That is to say, the pixel switching element 102 is formed so as to overlap the signal wiring 202 in a direction z vertical to the surface of the array substrate 11 through the interlayer insulating film 16.

In this embodiment, as shown in FIGS. 3 and 4, the pixel switching element 102 is a thin film transistor (TFT), and includes a semiconductor layer 14, a gate insulating film 102x, and a gate electrode 102g. The pixel switching element 102, for example, is the TFT using polysilicon, and, as shown in FIG. 4, is of a top gate type in which the semiconductor layer 14, the gate insulating film 102x, and the gate electrode 102g are formed in this order on the surface of the array substrate 11. Also, the pixel switching element 102 has the LDD structure.

That is to say, in the pixel switching element 102, as shown in FIG. 4, the semiconductor layer 14 is made of polysilicon, and first and second source/drain regions 102a and 102b are formed in pair so as to hold the channel formation region 102c between them.

In this case, in the first and second source/drain regions 102a and 102b formed in pair so as to hold the channel formation region 102c between them in the semiconductor layer 14, the first source/drain region 102a is connected to the signal wiring 202, and the second source/drain region 102b is connected to each of the pixel electrode 101 and the holding capacitor element 103.

In addition, the first and second source/drain regions 102a and 102b have first and second impurity diffusion regions 102Fa and 102Fb, and first and second low concentration impurity regions 102La and 102Lb, respectively. Here, the first and second impurity diffusion regions 102Fa and 102Fb are formed by diffusing an impurity into regions holding the channel formation region 102c between them in the semiconductor layer 14. Also, the first and second low concentration impurity regions 102La and 102Lb are formed by diffusing an impurity into the semiconductor layer 14 so that each of their impurity concentrations becomes lower than that of each of the first and second impurity diffusion regions 102Fa and 102Fb between each of the first and second impurity diffusion regions 102Fa and 102Fb, and the channel formation region 102c.

Also, the gate insulating film 102x is formed so as to just face the channel formation region 102c.

In addition, as shown in FIG. 4, the gate electrode 102g is formed so as to face the channel formation region 102c through the gate insulating film 102x, and as shown in FIG. 2, is connected to corresponding one of the scanning wirings 201.

Also, the pixel switching element 102 is driven and controlled in accordance with a scanning signal inputted from the gate driver 301 to the gate electrode 102g through the corresponding one of the scanning wirings 201. In addition, a data signal is supplied from the source driver 302 to the pixel switching element 102 through the corresponding one of the signal wiring 202. Also, when being held in the ON state, the pixel switching element 102 supplies the data signal to each of the pixel electrode 101 and the holding capacitor element 103.

As shown in FIG. 2, a plurality of holding capacitor elements 103 are disposed in matrix in the x direction and in the y direction so as to correspond to a plurality of pixel electrodes 101, respectively. Also, the holding capacitor element 103 is formed in parallel with a capacitance component of the liquid crystal layer 31, and holds therein electric charges due to the data signal applied across the liquid crystal layer 31. In addition, as shown in FIG. 3, the holding capacitor element 103 is formed so as to extend in the x direction and in the y direction in the array substrate 11. Here, a part, of the holding capacitor element 103, extending in the y direction is formed so as to correspond to the region in which the corresponding one of the signal wirings 202 is formed on the surface of the array substrate 11 similarly to the case of the pixel switching element 102. That is to say, the part of the holding capacitor element 103 is formed so as to overlap the corresponding one of the signal wirings 202 through the interlayer insulating film 16 in the direction z vertical to the surface of the array substrate 11. In addition, as shown in FIG. 4, the holding capacitor element 103 is formed on the surface side of the array substrate 11 facing the counter substrate 21 through the light shielding film 12 and the interlayer insulating film 13. Also, as shown in FIG. 4, the holding capacitor element 103 has an upper electrode 103a, a lower electrode 103b, and a dielectric film 103c. The lower electrode 103b, the dielectric film 103c and the upper electrode 103a are formed in this order from the side of the array substrate 11.

Here, the upper electrode 103a of the holding capacitor element 103 is made of a conductive material similarly to the case of the gate electrode 102g, and as shown in FIG. 2, is connected to the corresponding one of the holding capacitor wirings 203.

Also, as shown in FIGS. 2 and 4, the lower electrode 103b is connected to the second source/drain region 102b, on the side having no signal wiring 202 connected thereto, of the first and second source/drain regions 102a and 102b of the pixel switching element 102. In this embodiment, a region of the semiconductor layer 14 facing the upper electrode 103a functions as the lower electrode 103b.

In addition, the dielectric film 103c is formed so as to be sandwiched between the upper electrode 103a and the lower electrode 103b facing each other.

The scanning wirings 201, as shown in FIG. 2, are formed so as to extend in the x direction and each one of them is connected to a plurality of pixel switching elements 102 disposed in the x direction. In addition, a plurality of scanning wirings 201 are formed in parallel with each other to be kept apart from one another so that each one of them corresponds to a plurality of switching elements 102 disposed in the y direction. Also, each of the scanning wirings 201 is connected to the gate driver 301. Thus, the scanning signal is supplied from the gate driver 301 to the pixel switching elements 102 so as to successively select the rows of the pixel electrodes 101 through the scanning wirings 201.

Each of the signal wirings 202 is made of a conductive material. Also, as shown in FIGS. 2 and 3, the signal wirings 202 are formed to extend in the y direction so as to correspond to intervals at which a plurality of pixel electrodes 101 are disposed in the x direction, respectively, in the pixel region PR. Thus, each one of the signal wirings 202 is connected to a plurality of pixel switching elements 102 disposed in the y direction. In addition, a plurality of signal wirings 202 are formed in parallel with one another to be kept apart from one another in the x direction and each one of them is formed so as to correspond to a plurality of pixel switching elements 102 disposed in the y direction. Also, the data signal is supplied to each of the pixel electrodes 101 via the pixel switching elements 102, to each of which the scanning signal has been supplied, through the signal wirings 202. In addition, as shown in FIGS. 3 and 4, the signal wiring 202 is formed so as to include the region facing the pixel switching element 102 in the pixel region PR. Also, the signal wiring 202 is connected to the first source/drain region 102a of the pixel switching element 102. In this embodiment, as shown in the form of a region R1 surrounded by a dotted line in FIG. 4, the signal wiring 202 is connected to the first source/drain region 102a of the pixel switching element 102. Also, the signal wiring 202 is formed so as to include the region, other than the second source/drain region 102b, facing the first source/drain region 102a, in the pixel switching element 102. More specifically, as shown in FIG. 4, the signal wiring 202 is connected to the first impurity diffusion region 102Fa and is formed so as to face the first low concentration impurity region 102La and a part of the gate electrode 102g through only the interlayer insulating film 16. In addition, as shown in FIG. 3, a recess portion is formed in the signal wiring 202 in an xy plane so as to correspond to the portion having the pixel electrode relay portion 402 formed therein.

Each of the holding capacitor wirings 203, as shown in FIG. 2, is formed to extend in the x direction in the pixel region PR, and each one of them is connected to a plurality of holding capacitor elements 103 disposed in the x direction. In addition, a plurality of holding capacitor wirings 203 are formed in a line so as to be kept apart from one another in the y direction and so as to correspond to a plurality of holding capacitor elements 103 disposed in the y direction. Also, a side of the holding capacitor wirings 203 opposite to the holding capacitor elements 103 is connected to the counter electrode 23.

The holding capacitor element relay portion 401 is made of a conductive material, and performs the relay so as to connect the holding capacitor wiring 203 and the holding capacitor element 103 to each other. In this case, as shown in FIG. 3, the holding capacitor element relay portion 401 is formed in a line with the pixel electrode relay portion 402 in the x direction. In addition, as shown in FIG. 4, the holding capacitor element relay portion 401 is connected to the upper electrode 103a of the holding capacitor element 103.

The pixel electrode relay portion 402 is made of a conductive material, and performs the relay so as to connect the pixel electrode 101 and the pixel switching element 102 to each other. In this case, as shown in FIG. 3, the pixel electrode relay portion 402 extends in the x direction and is formed in a line with the holding capacitor element relay portion 401 in the x direction. In addition, in this embodiment, as shown in the form of a region R2 surrounded by a dotted line in FIG. 4, the pixel electrode relay portions 402 are connected to the second source/drain regions 102b of the pixel switching elements 102, respectively. Also, the pixel electrode relay portion 402 is formed so as to include the region, other than the first source/drain region 102a, facing the second source/drain region 102b in the pixel switching element 102. More specifically, as shown in FIG. 4, the pixel electrode relay portion 402 is connected to the second impurity diffusion region 102Fb. Also, the pixel electrode relay portion 402 is formed so as to face the second low concentration impurity region 102Lb and a part of the gate electrode 102g through only the interlayer insulating film 16. In this case, the pixel electrode relay portion 402 is formed so that a distance between an end portion on the signal wiring 202 side and an end portion of the signal wiring 202, for example, becomes equal to or larger than 0.5 μm. The reason for this is because a parasitic capacitance occurring between them is prevented from increasing.

(Manufacturing Method)

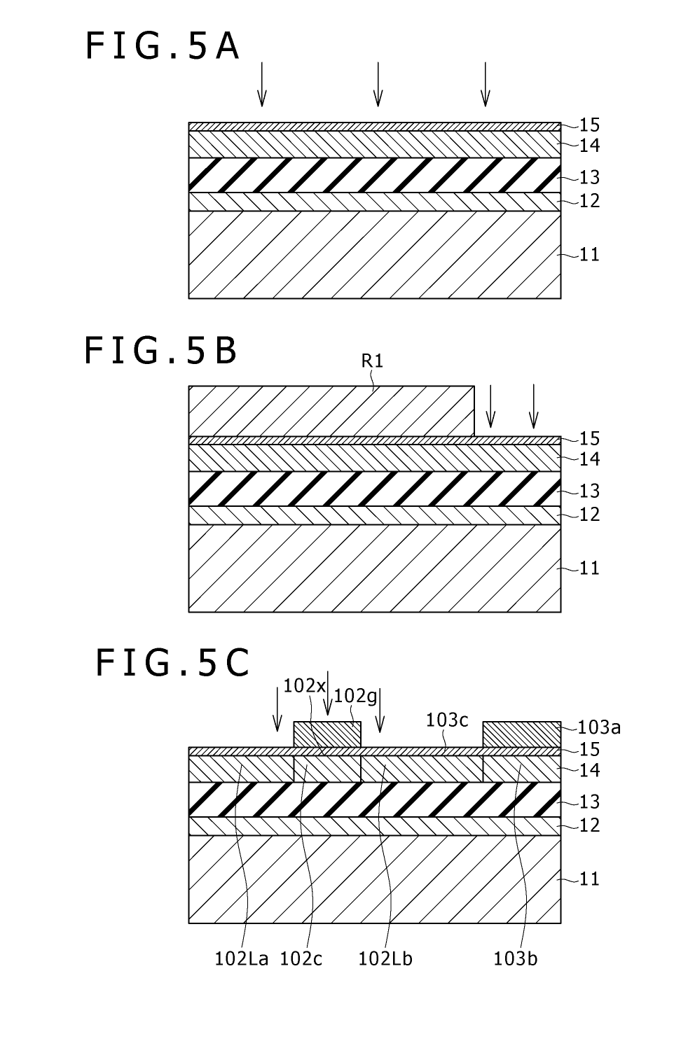

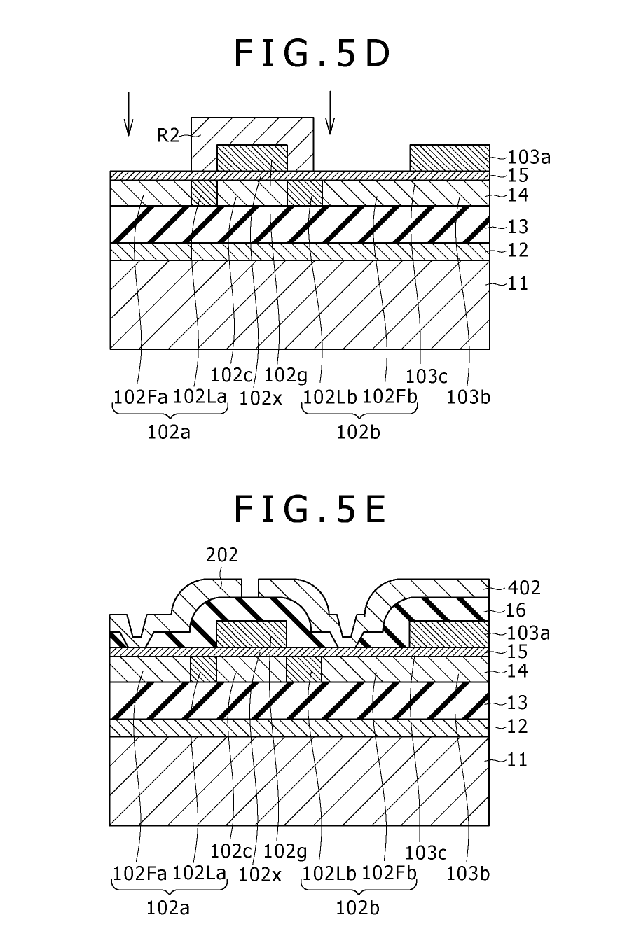

Hereinafter, a method of manufacturing the above-mentioned liquid crystal panel 1 will be described with reference to FIGS. 5A to 5E.

FIGS. 5A to 5E are respectively cross sectional views showing processes for the array substrate 11 side in the liquid crystal display device according to the first embodiment of the present invention.

Firstly, as shown in FIG. 5A, the light shielding film 12, the interlayer insulating film 13, the semiconductor layer 14, and the insulating film 15 are formed in order on the array substrate 11.

In this case, a conductor film made of a light shielding material such as a metal or silicide is deposited on the array substrate 11 to have a thickness of about 200 nm. After that, the conductor film is patterned so as to correspond to each of a formation region for the pixel switching element 102 and the holding capacitor element 103 formed on the array substrate 11, a formation region for the scanning wiring 201, thereby forming the light shielding film 12. That is to say, the light shielding film is formed so as to serve as the scanning wiring 201 as well. After that, the interlayer insulating film 13 made of a silicon oxide is formed to have a thickness of 400 to 600 nm by, for example, utilizing a chemical vapor deposition (CVD) method so as to cover the light shielding film 12.

Thereafter, an amorphous silicon film is formed on the interlayer insulating film 13 by, for example, utilizing the CVD method so as to cover each of a region in which the channel formation region 102c, and the first second source/drain regions 102a and 102b of the pixel switching element 102 are intended to be formed, and a region in which the holding capacitor element 103 is intended to be formed. Also, a heat treatment is performed for the amorphous silicon film to perform hydrogen desorption, thereby forming the semiconductor layer 14 formed of a polysilicon film.

Also, the semiconductor layer 14 is patterned. In this case, the patterning processing is carried out as follows. That is to say, as shown in FIG. 3, the semiconductor layer 14 is subjected to etching processing using an resist mask so as to correspond to each of the formation region for the channel formation region 102c, and the first and second source/drain regions 102a and 102b of the pixel switching element 102, and the formation region for the lower electrode 103b of the holding capacitor element 103 in the region having the light shielding film 12 formed therein. In this embodiment, the semiconductor layer 14 is formed so as to be bent at right angles in the region in which the gate electrode 102 is intended to be formed.

After that, the insulating film 15 is formed so as to correspond to each of a formation region for the gate insulating film 102x of the pixel switching element 102, and a formation region for the dielectric film 103c of the holding capacitor element 103. Also, impurity ions are implanted into the semiconductor layer 14 so as to obtain a predetermined threshold value.

Next, as shown in FIG. 5B, impurity ions are implanted into a region of the semiconductor layer 14 in which the lower electrode 103b of the holding capacitor element 103 is intended to be formed.

In this case, a region other than the region of the semiconductor layer 14 in which the lower electrode 103b of the holding capacitor element 103 is intended to be formed is covered with a resist mask R1. Thereafter, phosphorus ions are implanted, for example, with a dose of 1×10¹⁵/cm² into the region of the semiconductor layer 14 in which the lower electrode 103b of the holding capacitor element 103 is intended to be formed in the semiconductor layer 14. Then, the resist mask R1 is removed.

Next, as shown in FIG. 5C, the first and second low concentration impurity regions 102La and 102Lb of the pixel switching element 102 are formed after the gate electrode 102g of the pixel switching element 102, and the upper electrode 103a of the holding capacitor element 103 are formed.

In this case, a polysilicon film is deposited on a silicon oxide film of which each of the gate insulating film 102x and the dielectric film 103c is made by, for example, utilizing the CVD method. After that, the polysilicon film is made to turn into a conductor by being doped with phosphorus ions. Also, the resulting conductive polysilicon film is patterned by utilizing a suitable etching method using a resist mask, thereby forming the gate electrode 102g in a position corresponding to the channel formation region 102c of the semiconductor layer 14. In addition, similarly, the resulting conductive polysilicon film is patterned by utilizing the suitable etching method using a resist mask, thereby forming the upper electrode 103a of the holding capacitor element 103a. It is noted that the gate electrode 102g is also suitably formed through PDAS.

After that, the semiconductor layer 14 is doped with the phosphorus ions with each of the gate electrode 102g and the upper electrode 103a as a mask to form the first and second low concentration impurity regions 102La and 102Lb in the semiconductor layer 14 so as to hold the channel formation region 102c of the semiconductor layer 14 between them. The phosphorus ions are implanted into the semiconductor layer 14 with a dose of, for example, 1×10¹³ to 3×10¹³/cm². That is to say, the impurity ions are implanted into each of a region of the semiconductor layer 14 between the gate electrode 102g and the upper electrode 103a, and a region of the semiconductor layer 14 located on the side opposite to the region through the gate electrode 102g.

Next, as shown in FIG. 5D, the first impurity diffusion region 102Fa and the second impurity diffusion region 102Fb of the pixel switching element 102 are formed.

In this case, a region other than a region in which the first impurity diffusion region 102Fa and the second impurity diffusion region 102Fb of the pixel switching element 102 is intended to be formed in the semiconductor layer 14 is covered with a resist mask R2. After that, phosphorus ions are implanted with a dose of, for example, 1×10¹⁵/cm² into the region in which the first impurity diffusion region 102Fa and the second impurity diffusion region 102Fb of the pixel switching element 102 is intended to be formed in the semiconductor layer 14. The resist mask R2 is then removed.

Next, as shown in FIG. 5E, the signal wiring 202 and the pixel electrode relay portion 402 are formed.

In this case, the conductive layers such as the signal wiring 202 and the pixel electrode relay portion 402, and the interlayer insulating film 16 interposed between the pixel switching element 102 and the holding capacitor element 103 are firstly formed. A silicon oxide is deposited by, for example, utilizing the CVD method, thereby forming the interlayer insulating film 16. After that, a heat treatment is performed for the array substrate 11 to activate the impurity ions with which the semiconductor layer 14 is doped in the manner as described above.

After that, a contact hole is formed in the interlayer insulating film 16 so as to expose the surfaces of the first impurity diffusion region 102Fa and the second impurity diffusion region 102Fb. Then, a conductor film such as an aluminum film is deposited by, for example, utilizing a sputtering method so as to fill in the contact hole.

Also, the conductor film is patterned by performing etching processing using a resist mask, thereby forming the signal wiring 202 and the pixel electrode relay portion 402.

In this embodiment, the signal wiring 202 is formed so as to include a region, other than the second source/drain region 102b, which faces the first source/drain region 102a in the pixel switching element 102. More specifically, the signal wiring 202 is formed so as to include a portion facing each of the first low concentration impurity region 102La and a part of the gate electrode 102g through only the interlayer insulating film 16. In addition, at the same time, the pixel electrode relay portion 402 is formed so as to include a region, other than the first source/drain region 102a, which faces the second source/drain region 102b in the pixel switching element 102. More specifically, the pixel electrode relay portion 402 is formed so as to include a portion facing each of the second low concentration impurity region 102Lb and a part of the gate electrode 102g through only the interlayer insulating film 16.

After that, as shown in FIG. 4, a silicon oxide is deposited by, for example, utilizing a plasma CVD method so as to cover the signal wiring 202 and the pixel electrode relay portion 402, thereby forming the interlayer insulating film 17. Thereafter, flattening processing such as CMP processing is performed. Also, while not especially illustrated in the figures, after a contact hole is formed so as to expose the surface of the pixel electrode relay portion 402, a conductor film such as a titanium film is deposited so as to fill in the contact hole, thereby forming a connection conductive layer (not shown). Also, after an ITO film is deposited by utilizing the sputtering method so as to be electrically connected to the connection conductive layer, the ITO film is patterned, thereby forming the pixel electrode 101.

Note that, while an illustration is omitted here, the holding capacitor relay portion 401 is formed similarly to the case of the signal wiring 202 and the pixel electrode relay portion 402.

On the other hand, as shown in FIG. 4, the counter electrode 23 made of the ITO film is formed on the counter substrate 21.

After that, as shown in FIG. 4, the array substrate 11 having the pixel electrode 101 formed thereon, and the counter substrate 21 having the counter electrode 23 formed thereon are stuck to each other so that the pixel electrode 101 and the counter electrode 23 face each other. When the sticking of them is performed, firstly, an orientation film (not shown) made of polyimide is formed on each of the array electrode 11 and the counter substrate 21. Also, each of the orientation films is subjected to rubbing processing, and the array substrate 11 and the counter substrate 21 are bonded and stuck to each other by using a sealing material so as to have a predetermined gap between them. After that, the liquid crystal layer 31 is injected into the gap defined between the array substrate 11 and the counter substrate 21 and is oriented, thereby forming the liquid crystal cell.

Also, a driving circuit for driving the liquid crystal cell, and peripheral apparatuses such as a polarizing plate and a back light are mounted to the liquid crystal panel 1, thereby completing the liquid crystal display device of this embodiment.

(Operation)

Hereinafter, an operation of the liquid crystal display device in the liquid crystal display device of this embodiment will be described.

When the liquid crystal display device described above is driven, the gate driver 301 successively scan the scanning wirings 201 disposed in the y direction in a time division manner to sequentially supply the scanning signal to the scanning wirings 201, thereby turning ON the pixel switching elements 102. Also, the source driver 302 successively supplies the data signal to the signal wirings 202 in correspondence to the timings at which the scanning signal is sequentially supplied to the scanning wirings 201. Thus, the data signal is successively applied to the pixel electrodes 101 through the pixel switching elements 102 each being held in the ON state. As a result, the voltage is applied to the liquid crystal layer 31, so that the optical characteristics of the liquid crystal layer 31 change, thereby displaying an image.

In this case, when the liquid crystal panel 1 is driven in the manner as described above, the inverse driving is performed based on the alternating current in order to prevent the liquid crystal layer 31 from being deteriorated. The voltage is applied across the pixel electrode 101 and the counter electrode 23 in accordance with the inverse driving, and thus the orientation state of the liquid crystal layer 31 changes based on that voltage thus applied thereacross. The transmission of the light emitted from the light source such as the back light is controlled by changing the orientation state of the liquid crystal layer 31, thereby displaying an image on the screen.

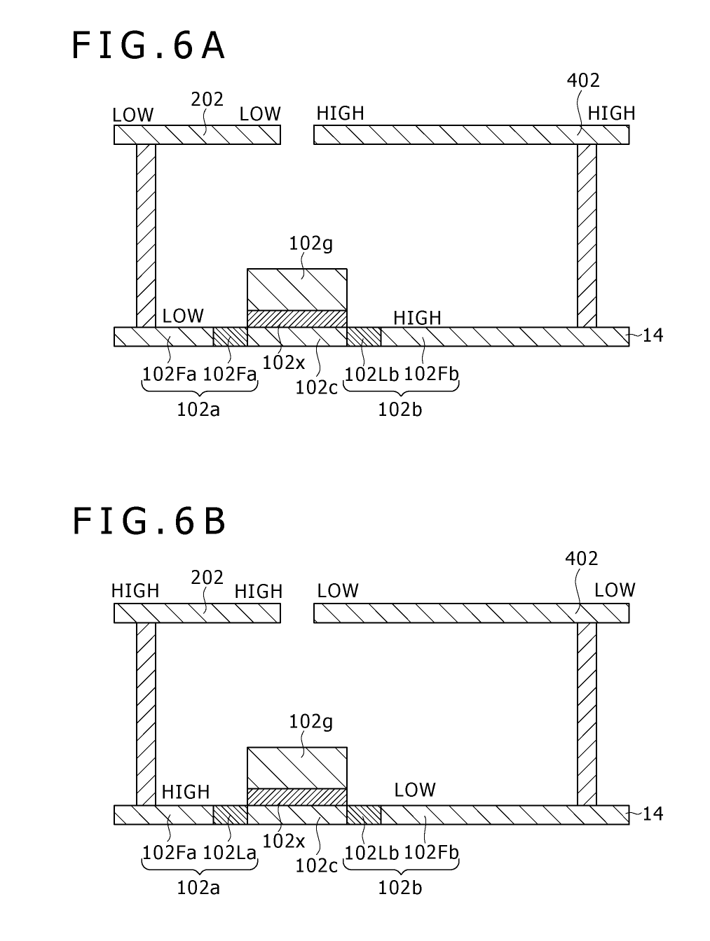

FIGS. 6A and 6B are respectively views each schematically showing the potentials which are held in the respective portions of the liquid crystal panel 1 after the gate is turned OFF when the liquid crystal panel 1 is inversely driven in the liquid crystal device according to the first embodiment of the present invention. That is to say, FIG. 6A shows the case where the high potential is written to the pixel electrode, and FIG. 6B shows the case where the low potential is written to the pixel electrode.

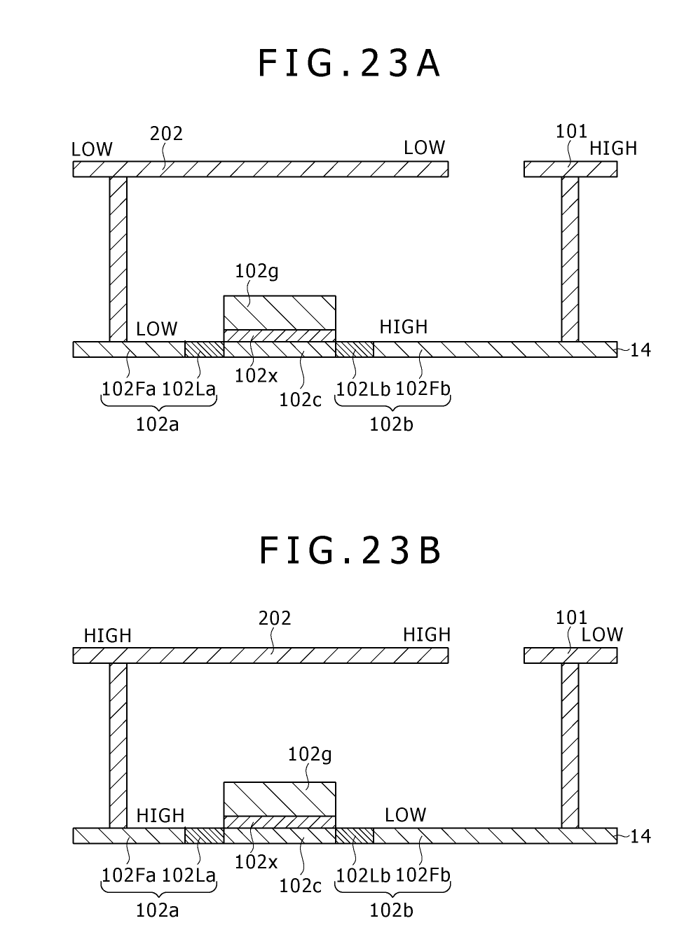

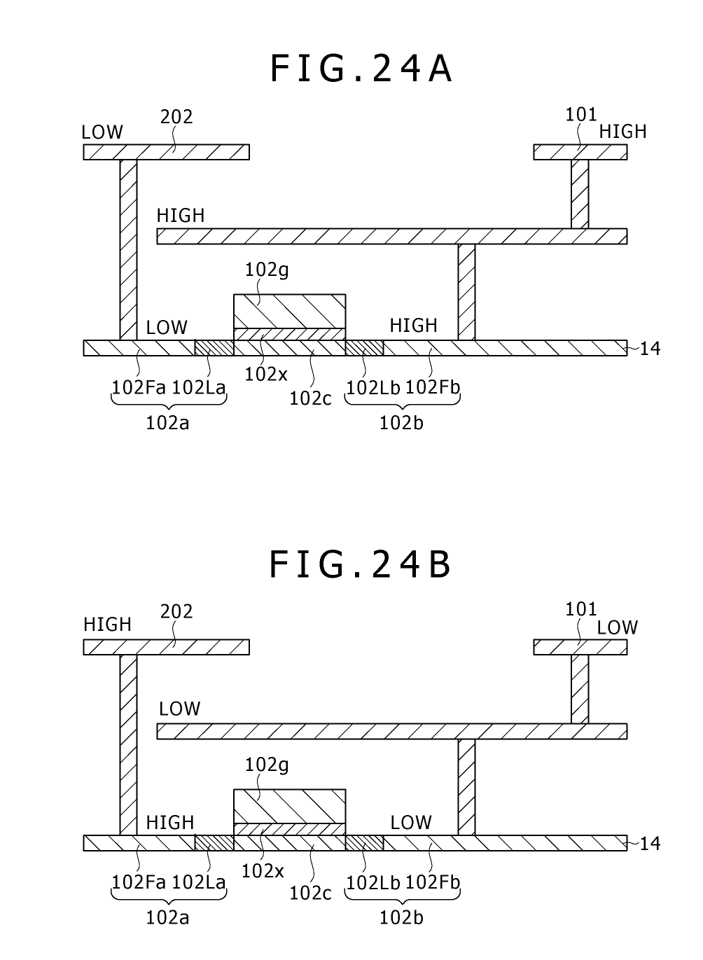

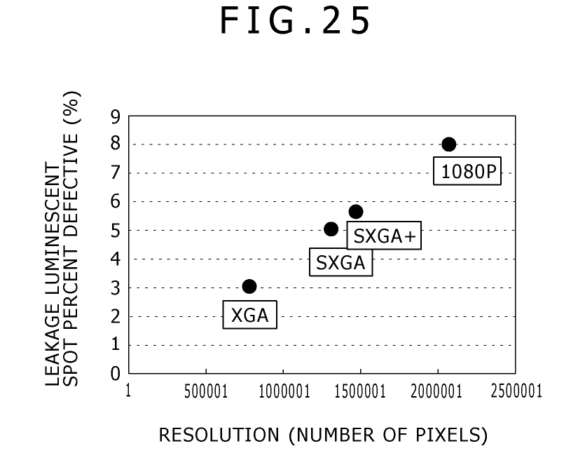

While the pixel electrode 101 holds the high potential HIGH, as shown in FIG. 6A, the signal wiring 202, and the first source/drain region 102a, on the side connected to the signal wiring 202, of a pair of source/drain regions 102a and 102b of the pixel switching element 102 are held at the same low potential LOW. On the other hand, the pixel electrode relay portion 402 connected to the pixel electrode 101, and the second source/drain region 102b, on the side connected to the pixel electrode 101, of a pair of source/drain regions 102a and 102b of the pixel switching element 102 are held at the same high potential HIGH. For this reason, unlike the above-mentioned case shown in FIG. 23A, no potential difference occurs between the portion of the second source/drain region 102b becoming the drain region in the pixel switching element 102, and the portion of the pixel electrode relay portion 402 which face each other through the interlayer insulating film 16. As a result, the frequency of occurrence of the leakage current in the phase of the OFF state becomes small.

On the other hand, while the pixel electrode 101 holds the low potential LOW, as shown in FIG. 6B, the signal wiring 202, and the first source/drain region 102a, on the side connected to the signal wiring 202, of a pair of source/drain regions 102a and 102b of the pixel switching element 102 are held at the same high potential HIGH. On the other hand, the pixel electrode relay portion 402 connected to the pixel electrode 101, and the second source/drain region 102b, on the side connected to the pixel electrode 101, of a pair of source/drain regions 102a and 102b of the pixel switching element 102 are held at the same low potential LOW. For this reason, unlike the above-mentioned case shown in FIG. 23B, no potential difference occurs between the portion of the first source/drain region 102a becoming the drain region in the pixel switching element 102, and the portion of the signal wiring 202. As a result, the frequency of occurrence of the leakage current in the phase of the OFF state becomes small.

As described above, in this embodiment, the signal wiring 202 through which the data is supplied, and the pixel electrode 101 are formed above the semiconductor layer 14 constituting the thin film transistor so as to protrude above the gate electrode 102g in the liquid crystal display device in which the thin film transistors are provided as the pixel switching elements 102 in matrix on the array substrate 11. Therefore, the potential of the region extending from the channel end of the pixel switching element 102 to the drain region, and the potential of the conductor layer facing that region become equal to each other in the phase of the inverse driving. As a result, it is possible to suppress the occurrence of the leakage current in the phase of the OFF state.

For this reason, in this embodiment, the occurrence of the leakage current in the phase of the OFF state can be suppressed, and also the OFF-phase potential holding characteristics in the phase of the driving at the high potential HIGH can be made equal to those in the phase of the driving at the low potential LOW. More specifically, in this embodiment, the leakage current value can be reduced by about one digit as compared with the structure of the related art, which results in that the potential of that region, and the potential of the conductor layer can be equalized to each other in the phase of the inverse driving.

Therefore, in this embodiment, when the pixel switching element 102 is formed on the surface of the array substrate 11 so as to face each of the conductive layers such as the signal wiring 202 and the pixel electrode relay portion 402 in order to improve the aperture ratio of the pixel region, it is possible to prevent that the image holding characteristics are reduced due to the occurrence of the leakage current in the phase of the OFF state, and the flicker and the residual image occur in the phase of the inverse driving. As a result, it is possible to improve the image quality.

It is noted that in the first embodiment described above, the array substrate 11 corresponds to a substrate in the display device of the present invention. In addition, in the first embodiment described above, the semiconductor layer 14 corresponds to a semiconductor layer in the display device of the present invention. In addition, in the first embodiment described above, the interlayer insulating film 16 corresponds to an interlayer insulating film in the display device of the present invention. In addition, in the first embodiment described above, the counter substrate 21 corresponds to a counter substrate in the display device of the present invention. In addition, in the first embodiment described above, the liquid crystal layer 31 corresponds to a liquid crystal layer in the display device of the present invention. In addition, in the first embodiment described above, the pixel electrode 101 corresponds to a pixel electrode in the display device of the present invention. In addition, in the first embodiment described above, the pixel switching element 102 corresponds to a pixel switching element in the display device of the present invention. In addition, in the first embodiment described above, the gate insulating film 102x corresponds to a gate insulating film in the display device of the present invention. Also, in the first embodiment described above, the gate electrode 102g corresponds to a gate electrode in the display device of the present invention. Also, in the first embodiment described above, the channel formation region 102c corresponds to a channel formation region in the display device of the present invention. Also, in the first embodiment described above, the first source/drain region 102a corresponds to a first source/drain region in the display device of the present invention. Also, in the first embodiment described above, the second source/drain region 102b corresponds to a second source/drain region in the display device of the present invention. Also, in the first embodiment described above, the first impurity diffusion region 102Fa corresponds to a first impurity diffusion region in the display device of the present invention. Also, in the first embodiment described above, the second impurity diffusion region 102Fb corresponds to a second impurity diffusion region in the display device of the present invention. Also, in the first embodiment described above, the first low concentration impurity region 102La corresponds to a first low concentration impurity region in the display device of the present invention. Moreover, in the above-mentioned embodiment, the second low concentration impurity region 102Lb corresponds to a second low concentration impurity region in the display device of the present invention. Moreover, in the above-mentioned embodiment, the holding capacitor element 103 corresponds to a holding capacitor element in the display device of the present invention. Moreover, in the above-mentioned embodiment, the upper electrode 103a corresponds to a first electrode in the display device of the present invention. Moreover, in the above-mentioned embodiment, the lower electrode 103b corresponds to a second electrode in the display device of the present invention. Moreover, in the above-mentioned embodiment, the dielectric film 103c corresponds to a dielectric film in the display device of the present invention. Further, in the above-mentioned embodiment, the signal wiring 202 corresponds to a first conductive layer in the display device of the present invention. Further, in the above-mentioned embodiment, the pixel electrode relay portion 402 corresponds to a second conductive layer in the display device of the present invention. Also, in the above-mentioned embodiment, the pixel region PR corresponds to a pixel region in the display device of the present invention.

### Second Embodiment

(Structure)

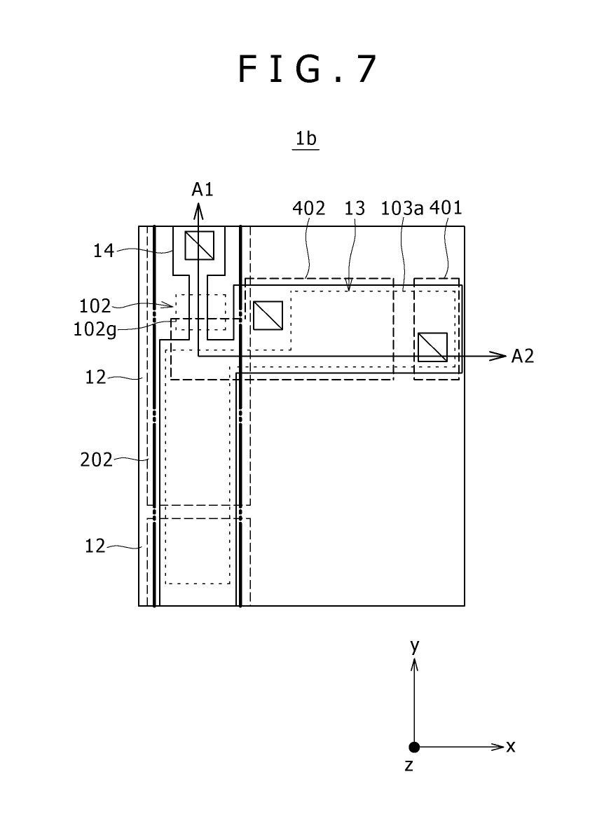

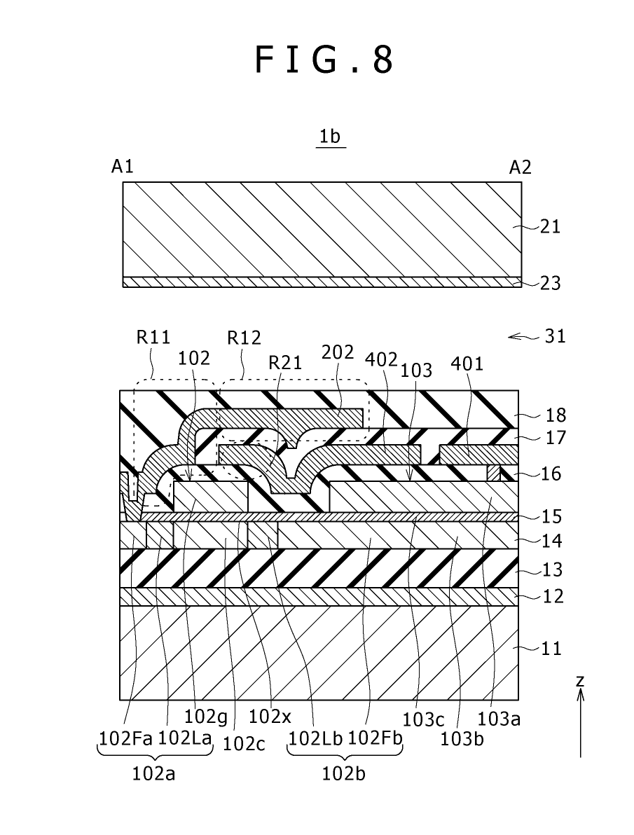

FIGS. 7 and 8 are respectively views each showing a main portion of a liquid crystal panel 1b in a liquid crystal display device according to a second embodiment of the present invention.

Here, FIG. 7 is a plan view showing a part of the liquid crystal panel 1b in the liquid crystal display device according to the second embodiment of the present invention. In addition, FIG. 8 is a cross sectional view showing a part of the liquid crystal panel 1b in the liquid crystal display device according to the second embodiment of the present invention. FIG. 8 shows a portion a surrounded by a dashed line in FIG. 2. Also, FIG. 8 showing portions from the array substrate 11 to the interlayer insulating film 18 is taken on line A1-A2 of FIG. 7.

As shown in FIGS. 7 and 8, the shapes of the signal wiring 202 and the pixel electrode relay portion 402 in the liquid crystal panel 1b of the liquid crystal display device of this embodiment are different from those in the liquid crystal panel 1 of the liquid crystal display device of the first embodiment. The constitution of this embodiment is approximately the same as that of the first embodiment except for this respect. For this reason, the repeated portions are omitted here in their descriptions. Thus, portions different from those in the first embodiment will now be described.

As shown in FIGS. 7 and 8, the signal wirings 202 are formed extendedly in the y direction so as to correspond to the intervals at which a plurality of pixel electrodes 101 are disposed in the x direction, respectively, in the pixel region PR similarly to the case of the first embodiment 1. Also, each one of the signal wirings 202 is connected to a plurality of pixel switching elements 102 disposed in the y direction.

In addition, as shown in FIGS. 7 and 8, the signal wiring 202 is formed so as to include a region facing the pixel switching element 102 in the pixel region PR, and is connected to the first source/drain region 102a of the pixel switching element 102. In this embodiment, as shown in the form of a region R11 surrounded by a dotted line in FIG. 8, the signal wiring 202 is connected to the first source/drain region 102a of the switching element 102. Also, the signal wiring 202 is formed so as to include a region, other than the second source/drain region 102b, which faces the source/drain region 102a in the pixel switching element 102. More specifically, the signal wiring 202 is connected to the first impurity diffusion region 102Fa, and is formed so as to face the first low concentration impurity region 102La and a part of the gate electrode 102g through the interlayer insulating films 16 and 17.

Also, in addition thereto, in this embodiment, the signal wiring 202 is formed so as to include a region facing the second source/drain region 102b of the pixel switching element 102 through the pixel electrode relay portion 402. More specifically, as shown in the form of a region R12 surrounded by a dotted line in FIG. 8, a region of the signal wiring 202 facing the second source/drain region 102b of the pixel switching element 102 is formed through the pixel electrode relay portion 402 as the conductive layer as well as the interlayer insulating films 16 and 17. That is to say, the signal wiring 202 is formed so as to face each of the part of the gate electrode 102g, the second low concentration impurity region 102Lb and the second impurity diffusion region 102Fb through the interlayer insulating films 16 and 17, and the pixel electrode relay portion 402.

An interlayer insulating film 18 is formed over the signal wiring 202.

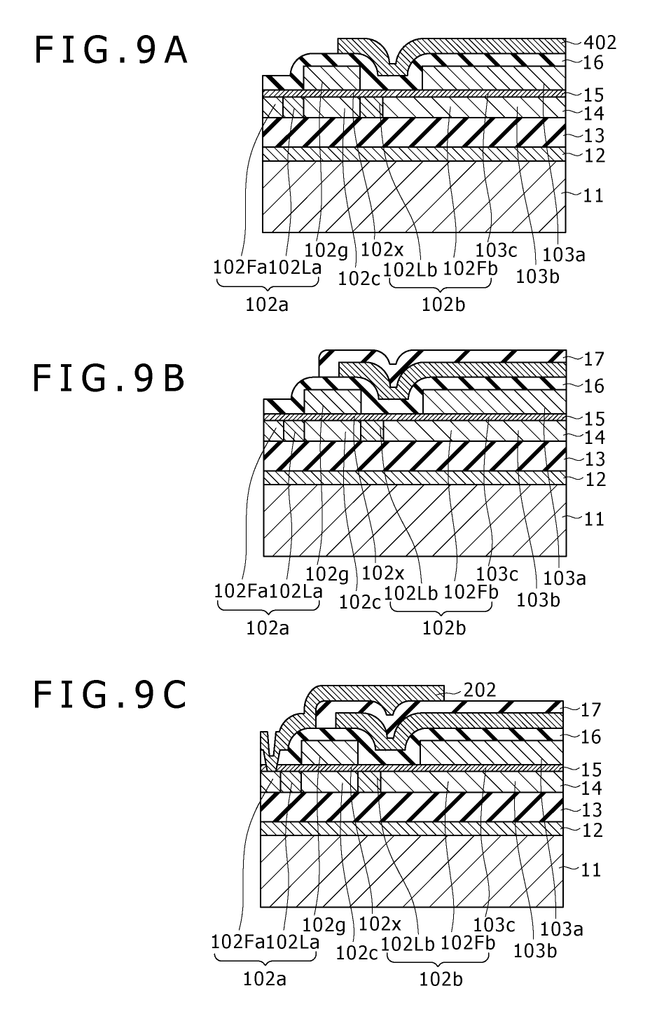

As shown in FIGS. 7 and 8, a plurality of pixel electrode relay portions 402 are formed so as to correspond to the intervals at which a plurality of pixel electrodes 101 are disposed in the y direction, respectively, in the pixel region PR similarly to the case of the first embodiment. In this embodiment, the pixel electrode relay portions 402 are connected to the second source/drain regions 102b of the pixel switching elements 102, respectively, (not shown). Also, as shown in the form of a region R21 surrounded by a dotted line in FIG. 9, the pixel electrode relay portion 402 is formed so as to include a region, other than the first source/drain region 102a of the pixel switching element 102, which faces the second source/drain region 102b. More specifically, as shown in FIG. 8, the pixel electrode relay portion 402 is connected to the second impurity diffusion region 102Fb, and is formed so as to face each of the second low concentration impurity region 102Lb and the part of the gate electrode 102g through the interlayer insulating film 16.

(Manufacturing Method)

Hereinafter, a method of manufacturing the above-mentioned liquid crystal panel 1b of the liquid crystal display device according to the second embodiment of the present invention will be described with reference to FIGS. 9A to 9C.

When the above-mentioned liquid crystal panel 1b is manufactured, the first impurity diffusion region 102Fa and the second impurity diffusion region 102Fb of the pixel switching element 102 are formed through the same processes as those in the first embodiment as shown in FIGS. 5A to 5D.

After that, as will be described below, the liquid crystal panel 1b in the liquid crystal display device of the second embodiment will be completed.

FIGS. 9A to 9C are respectively cross sectional views showing processes for the array substrate 11 side in the second embodiment of the present invention. In FIGS. 9A to 9C, the processes for the array substrate 11 side are shown in order of FIG. 9A, FIG. 9B and FIG. 9C.

After the above-mentioned processes are carried out, as shown in FIG. 9A, the pixel electrode relay portion 402 is formed.

In this case, the interlayer insulating film 16 is firstly formed which is interposed between the pixel electrode relay portion 402 and each of the pixel switching element 102 and the holding capacitor element 103. For example, a silicon oxide film is deposited by utilizing the CVD method, thereby forming the interlayer insulating film 16. After that, a heat treatment is performed for the array substrate 11, thereby activating the impurity ions with which the semiconductor layer is doped in the manner as described above.

After that, a contact hole is formed in the interlayer insulating film 16 so as to expose the surface of the second impurity diffusion region 102Fb. Then, the conductor film such as the aluminum film is deposited by, for example, utilizing the sputtering method so as to fill in the contact hole.

Also, etching processing using a resist mask is carried out to pattern the conductor film, thereby forming the pixel electrode relay portion 402.

In this embodiment, the pixel electrode relay portion 402 is formed so as to include a region, other than the first source/drain region 102a, which faces the second source/drain region 102b of the pixel switching element 102. More specifically, the pixel electrode relay portion 402 is formed so as to include the region which faces each of the second low concentration impurity region 102Lb and the part of the gate electrode 102g through only the interlayer insulating film 26.

Next, as shown in FIG. 9B, the interlayer insulating film 17 is formed.

In this case, the interlayer insulating film 17 is formed so as to cover the pixel electrode relay portion 402. After a silicon oxide film is deposited by, for example, utilizing the CVD method, a region other than the region in which the signal wiring 202 is intended to be formed is covered with a resist mask. Then, the silicon oxide film is selectively etched away, thereby forming the interlayer insulating film 17.

Next, as shown in FIG. 9C, the signal wiring 202 is formed.

In this case, after the contact hole is formed so as to expose the surface of the first impurity diffusion region 102Fa, the conductor film such as the aluminum film is deposited by, for example, utilizing the sputtering method to fill in that contact hole.

Also, the etching processing using the resist mask is carried out to pattern the conductor film, thereby forming the signal wiring 202.

In this embodiment, as described above, a region of the signal wiring 202 facing the first source/drain region 102a of the pixel switching element 102 is formed through only the interlayer insulating films 16 and 17. Also, a region of the signal wiring 202 facing the second source/drain region 102b of the pixel switching element 102 is formed through the pixel electrode relay portion 402 as the conductive layer in addition to the interlayer insulating films 16 and 17.

After that, as shown in FIG. 8, a silicon oxide is deposited by, for example, utilizing the plasma CVD method so as to cover each of the signal wiring 202 and the pixel electrode relay portion 402, thereby forming the interlayer insulating film 18. Thereafter, the liquid crystal display device is completed similarly to the case of the first embodiment.

(Operation)

Hereinafter, an operation of the liquid crystal panel 1b in the liquid crystal display device of this embodiment will be described.

When the above-mentioned the liquid crystal panel 1b is driven, it is driven as shown in FIGS. 6A and 6B similarly to the case of the first embodiment.

For this reason, in this embodiment, it is possible to suppress the occurrence of the leakage current in the phase of the OFF state. Also, the OFF-phase potential holding characteristics in the phase of the driving at the high potential HIGH can be equalized to those in the phase of the driving at the low potential LOW similarly to the case of the first embodiment.

Therefore, in this embodiment, when the pixel switching element 102 is formed on the surface of the array substrate 11 so as to face each of the conductive layers such as the signal wiring 202 and the pixel electrode relay portion 402 in order to improve the aperture ratio of the pixel region, it is possible to prevent that the image holding characteristics are reduced due to the occurrence of the leakage current in the phase of the OFF state, and that the flicker and the residual image occur in the phase of the inverse driving. As a result, it is possible to improve the image quality.

It is noted that the members of this embodiment described above correspond to the constituent elements of the display device of the present invention similarly to the case of the first embodiment.

### Third Embodiment

(Structure)

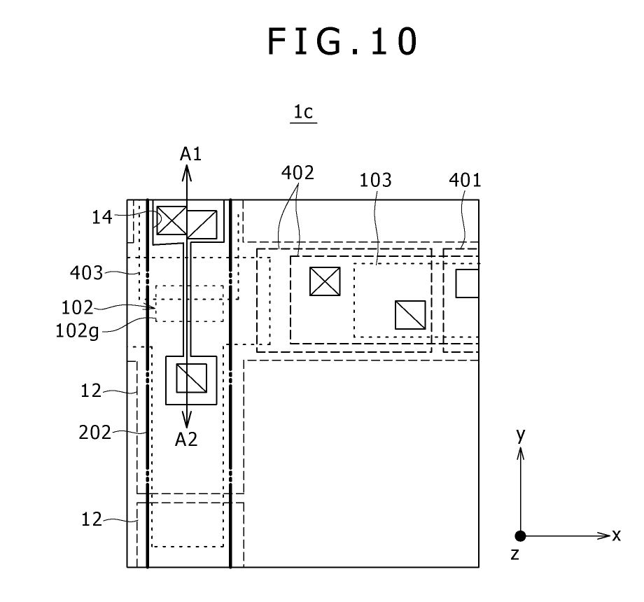

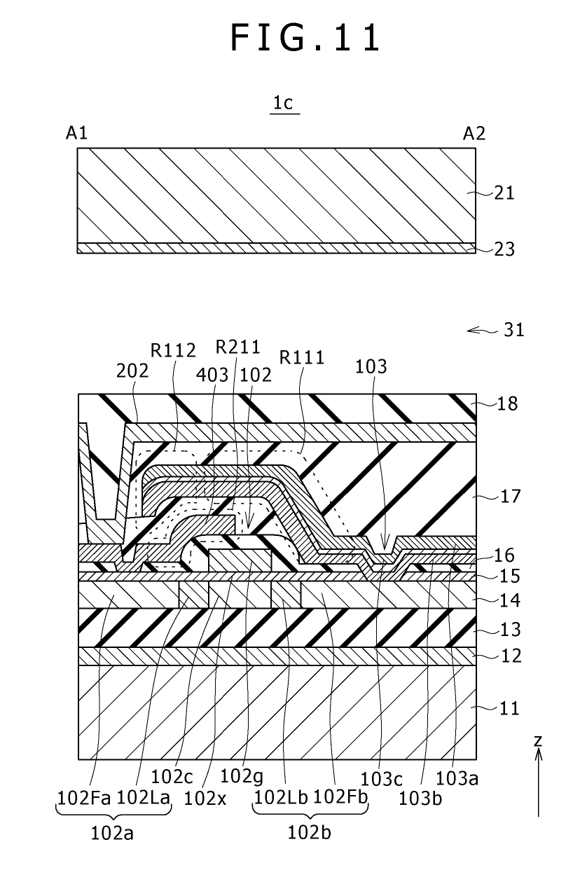

FIGS. 10 and 11 are respectively views each showing a liquid crystal panel 1c in a liquid crystal display device according to a third embodiment of the present invention.

Here, FIG. 10 is a plan view showing a part of the liquid crystal panel 1c in the liquid crystal display device according to the third embodiment of the present invention. FIG. 11 is a cross sectional view showing a part of the liquid crystal panel 1c in the liquid crystal display device according to the third embodiment of the present invention. Also, each of FIGS. 10 and 11 shows the portion a surrounded by the dashed line in FIG. 2. FIG. 11 showing portions from the array substrate 11 to the interlayer insulating film 18 is taken on line A1-A2 of FIG. 10.

As shown in FIGS. 10 and 11, the holding capacitor element 103 of the liquid crystal panel 1c in the liquid crystal display device of this embodiment is different from that of the liquid crystal panel 1c in the liquid crystal display device of the second embodiment. Also, the liquid crystal panel 1c in the liquid crystal display device of this embodiment includes a signal wiring relay portion 403. The constitution of this embodiment is approximately the same as that of the second embodiment except for those respects. Thus, the repeated portions are omitted here in their descriptions.

As shown in FIG. 10, the holding capacitor elements 103 are respectively formed in the portions where the intervals at which a plurality of pixel electrodes 101 are disposed in the x direction cross the intervals at which a plurality of pixel electrodes 101 are disposed in the y direction so as to extend in the y direction and in the x direction. In addition, as shown in FIG. 11, the holding capacitor element 103 includes the upper electrode 103a, the lower electrode 103b, and the dielectric film 103c. The lower electrode 103b, the dielectric film 103c, and the upper electrode 103a are formed in this order from the pixel switching element 102 side. Also, the holding capacitor element 103 is formed so as to include the region facing the pixel switching element 102. The lower electrode 103b is connected to the second source/drain region 102b of the pixel switching element 102. In this embodiment, the holding capacitor element 103 is formed so as to be sandwiched between the pixel switching element 102 and the signal wiring 202 in the vertical direction z in the pixel region PR. More specifically, as shown in the form of a region R111 surrounded by a dotted line in FIG. 11, the lower electrode 103b of the holding capacitor element 103 is formed so as to face the region, other than the first source/drain region 102a, which includes the second source/drain region 102a in the pixel switching element 102 through only the interlayer insulating films 16 and 17. In addition, as shown in the form of a region R112 surrounded by a dotted line in FIG. 11, the holding capacitor element 103 includes a region facing the first source/drain region 102a of the pixel switching element 102. In the region facing the first source/drain region 102a, the lower electrode 103b is formed so as to face that region facing the first source/drain region 102a through the signal wiring relay portion 403 as the conductive layer as well as the interlayer insulating films 16 and 17.

The signal wiring relay portion 403 is made of a conductive material. Also, as shown in FIGS. 10 and 11, a plurality of signal wiring relay portions 403 are formed so as to correspond to the intervals at which a plurality of pixel electrodes 101 are disposed in the x direction in the pixel region PR, and so as to extend in the y direction. Also, the signal wiring relay portion 403 is connected so as to relay the signal wiring 202 and the pixel switching element 102. In addition, as shown in FIGS. 10 and 11, the signal wiring relay portion 403 is formed so as to include the region facing the pixel switching element 102 in the pixel region PR, and is connected to the pixel switching element 102. In this embodiment, as shown in the form of a region R211 surrounded by a dotted line in FIG. 11, the signal wiring relay portion 403 is connected to the first source/drain region 102a of the pixel switching element 102. Also, the signal wiring relay portion 403 is formed so as to include the region, other than the second source/drain region 102a of the pixel switching element 102, which faces the first source/drain region 102a. More specifically, the signal wiring relay portion 403, as shown in FIG. 11, is connected to the first impurity diffusion region 102Fa. Also, the signal wiring relay portion 403 is formed so as to face each of the first low concentration impurity region 102La and the part of the gate electrode 102g through only the interlayer insulating film 16.

(Manufacturing Method)

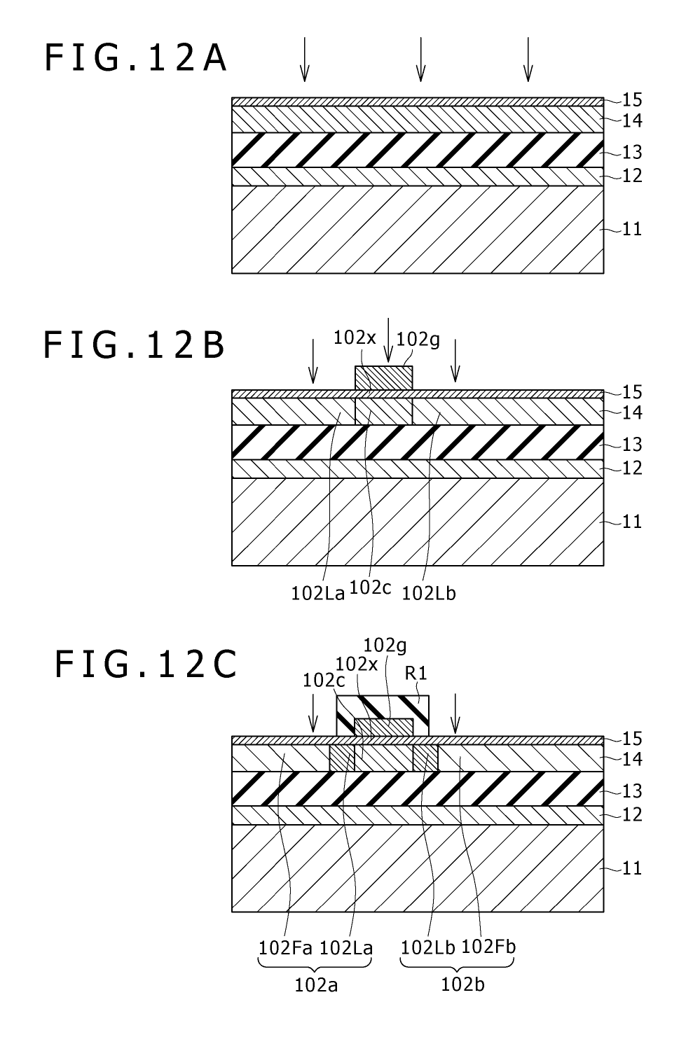

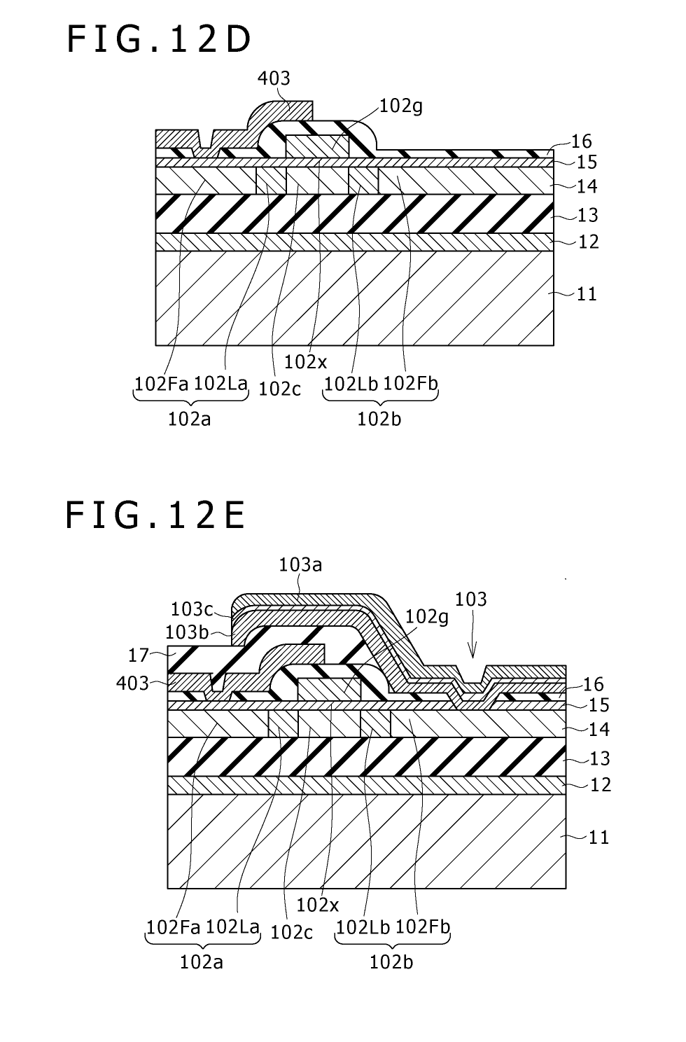

Hereinafter, a method of manufacturing the above-mentioned liquid crystal panel 1c of the liquid crystal display device of this embodiment will be described with reference to FIGS. 12A to 12E.

FIGS. 12A to 12E are respectively cross sectional views showing processes for the array substrate 11 side in the liquid crystal display device according to the third embodiment of the present invention.

Firstly, as shown in FIG. 12A, the light shielding film 12, the interlayer insulating film 13, the semiconductor layer 14, and the insulating film 15 are formed in this order on the array substrate 11 similarly to the case of the first embodiment.

Next, as shown in FIG. 12B, the gate electrode 102g of the pixel switching element 102 is formed, and also the first and second low concentration impurity regions 102La and 102Lb of the pixel switching element 102 are formed.

In this case, a polysilicon film is deposited on a silicon oxide film of which the gate insulating film 102x is made by, for example, utilizing the CVD method. After that, the polysilicon film is doped with phosphorus ions to be caused to turn into the conductor film. Also, the resulting conductive polysilicon film is patterned by utilizing a suitable etching method using a resist mask, thereby forming the gate electrode 102g in a position corresponding to the channel formation region 102c of the semiconductor layer 14. After that, the semiconductor layer 14 is doped with the phosphorus ions with the gate electrode 102g as the mask, thereby forming the first and second low concentration impurity regions 102La and 102Lb in the semiconductor layer 14 so as to hold the channel formation region 102c of the semiconductor layer 14 between them. For example, the phosphorus ions are implanted into the semiconductor layer 14 with a dose of 1×10¹³ to 3×10¹³/cm².

Next, as shown in FIG. 12C, the first and second impurity diffusion regions 102Fa and 102Fb of the pixel switching element 102 are formed in the semiconductor layer 14.

In this case, the region other than the regions in which the first and second impurity diffusion regions 102Fa and 102Fb of the pixel switching element 102 are intended to be formed in the semiconductor layer 14 is covered with a resist mask R1. After that, the phosphorus ions are implanted with a dose of, for example, 1×10¹⁵/cm² into each of the regions in which the first and second impurity diffusion regions 102Fa and 102Fb of the pixel switching element 102 are intended to be formed in the semiconductor layer 14. The resist mask R1 is then removed.

Next, as shown in FIG. 12D, the signal wiring relay portion 403 is formed.

In this case, firstly, the silicon oxide is deposited by, for example, utilizing the CVD method, thereby forming the interlayer insulating film 16. After that, a heat treatment is performed for the array substrate 11, thereby activating the impurity ions with which the semiconductor layer 14 is doped in the manner as described above.

After that, a contact hole is formed in the interlayer insulating film 16 so as to expose the surface of the first impurity diffusion region 102Fa. Then, the conductor film such as the aluminum film is deposited by, for example, utilizing the sputtering method so as to fill in the contact hole.

Also, etching processing using a resist mask is carried out to pattern the conductor film, thereby forming the signal wiring relay portion 403. In this embodiment, as described above, the signal wiring relay portion 403 is formed so as to include the region, other than the second source/drain region 102b, which faces the first source/drain region 102a of the pixel switching element 102. More specifically, the signal wiring relay portion 403 is formed so as to be connected to the first impurity diffusion region 102Fa through only the insulating film 15 and so as to face each of the first low concentration impurity region 102La and the part of the gate electrode 102g through only the insulating film 15 and the interlayer insulating film 16.

Next, as shown in FIG. 12E, the holding capacitor element 103 is formed.

In this case, firstly, a silicon oxide is deposited by, for example, utilizing the CVD method, thereby forming the interlayer insulating film 17 so as to cover the signal wiring relay portion 403.

After that, the contact hole is formed in the interlayer insulating film 16 so as to expose the surface of the second impurity diffusion region 102Fa. After that, the lower electrode 103b, the dielectric film 103c, and the upper electrode 103a of the holding capacitor element 103 are formed in this order. In this embodiment, as described above, the lower electrode 103b of the holding capacitor element 103 is formed so as to face the region, other than the first source/drain region 102a, which includes the second source/drain region 102b of the pixel switching element 102 through only the interlayer insulating films 16 and 17. Also, the region of the lower electrode 103b facing the first source/drain region 102a is formed through the signal wiring relay portion 403 and the interlayer insulating films 16 and 17.

Also, as shown in FIG. 11, the interlayer insulating film 18 made of a silicon oxide is formed by, for example, utilizing the CVD method so as to cover the holding capacitor element 103. Also, the signal wiring 202 is formed similarly to the case of the first embodiment. After that, the portions of the liquid crystal panel 1c are formed similarly to the case of the first embodiment, thereby completing the liquid crystal display device.

(Operation)

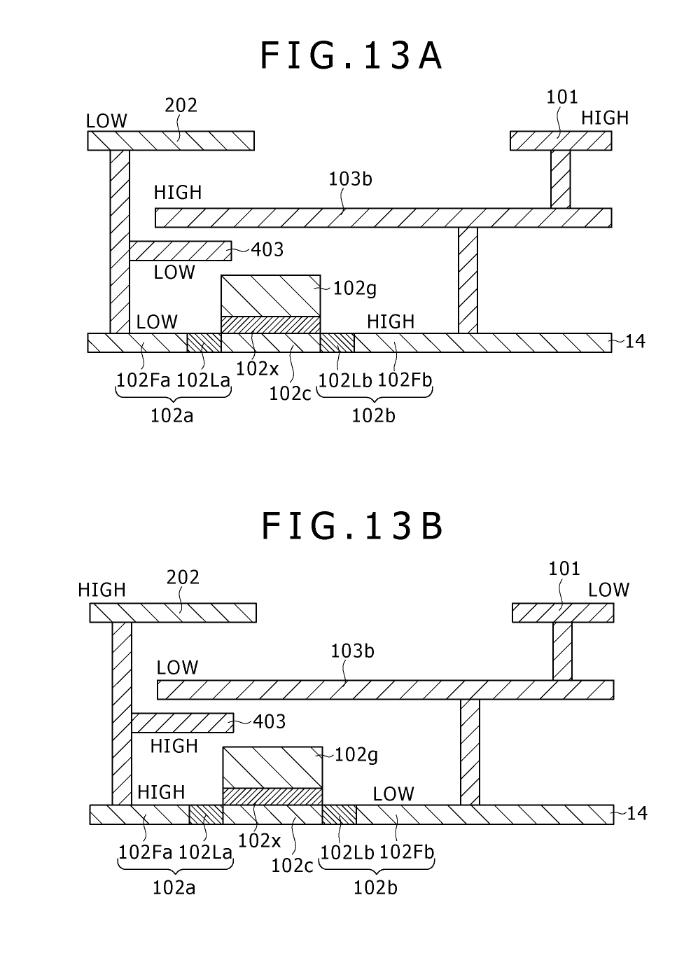

Hereinafter, an operation of the liquid crystal panel 1c in the liquid crystal display device of this embodiment will be described with reference to FIGS. 13A and 13B.

FIGS. 13A and 13B are respectively views each showing the potentials which are held in the respective portions of the liquid crystal panel 1c after the gate is turned OFF when the liquid crystal panel 1c is inversely driven in the third embodiment of the present invention. That is to say, FIG. 13A shows the case where the high potential is written to the pixel electrode, and FIG. 13B shows the case where the low potential is written to the pixel electrode.

As shown in FIG. 13A, while the pixel electrode 101 holds thereat the high potential HIGH, the second source/drain region 102b becoming the drain region in the pixel switching element 102, and the lower electrode 103b of the holding capacitor element 103 facing the second source/drain region 102b are connected to each other, and have the same potential.

On the other hand, as shown in FIG. 13B, while the pixel electrode 101 holds thereat the low potential LOW, the first source/drain region 102a becoming the drain region in the pixel switching element 102, and the lower electrode 103b of the holding capacitor element 103 facing the first source/drain region 102a are different in potential from each other. In this embodiment, however, in addition to the interlayer insulating films 16 and 17, the signal wiring relay portion 403 held at the same potential as that of the first source/drain region 102a is interposed between the first source/drain region 102a and the lower electrode 103b facing each other. Also, the first source/drain region 102a and the signal wiring relay portion 403 face each other.

For this reason, in this embodiment, it is possible to suppress the occurrence of the leakage current in the phase of the OFF state. Also, the OFF-phase potential holding characteristics in the phase of the driving at the high potential HIGH can be equalized to the that in the phase of the driving at the low potential LOW. Therefore, in this embodiment, when the pixel switching element 102 is formed on the surface of the array substrate 11 so as to face each of the conductive layers such as the signal wiring 202 and the holding capacitor element 103 in order to improve the aperture ratio of the pixel region, it is possible to prevent that the image holding characteristics are reduced due to the occurrence of the leakage current in the phase of the OFF state, and that the flicker and the residual image occur in the phase of the inverse driving. As a result, it is possible to improve the image quality.

Note that, in this embodiment described above, the signal wiring relay portion 403 corresponds to the first conductive layer in the display device of the present invention. In addition, in this embodiment described above, the lower electrode 103b corresponds to the second conductive layer in the display device of the present invention. Other members of this embodiment correspond to the constituent elements in the display device of the present invention, respectively.

### Fourth Embodiment

(Structure)

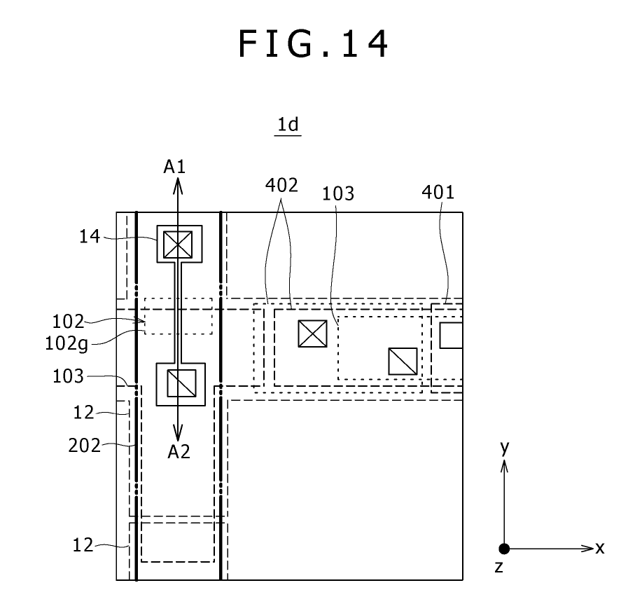

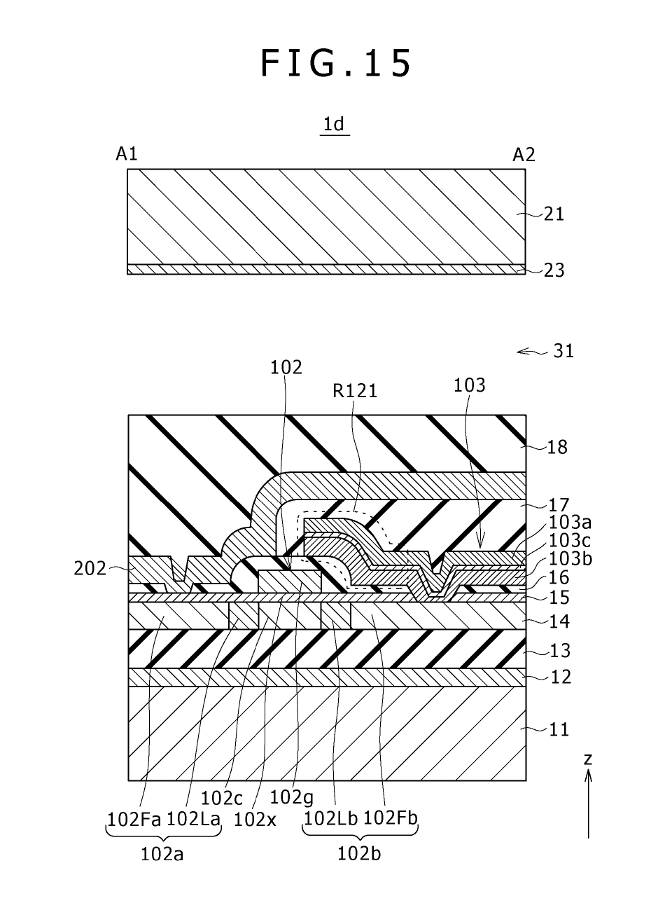

FIGS. 14 and 15 are respectively views each showing a liquid crystal panel 1d in a liquid crystal display device according to a fourth embodiment of the present invention.

FIG. 14 is a plan view showing a part of the liquid crystal panel 1d in the liquid crystal display device according to the fourth embodiment of the present invention. Also, FIG. 15 is a cross sectional view showing a part of the liquid crystal panel 1d in the liquid crystal display device according to the fourth embodiment of the present invention. Each of FIGS. 14 and 15 shows the portion a surrounded by the dashed line in FIG. 2. FIG. 15 showing portions from the array substrate 11 to the interlayer insulating film 18 is taken on line A1-A2 of FIG. 14.

As shown in FIGS. 14 and 15, the holding capacitor element 103 of the liquid crystal panel 1d in the liquid crystal display device of this embodiment is different in structure from that of the liquid crystal panel 1b in the liquid crystal display device of the second embodiment 2. The constitution of this embodiment is approximately the same as that of the second embodiment except for this respect.

As shown in FIG. 14, the holding capacitor elements 103 are respectively formed so as to extend in the x direction from the portions where the intervals at which a plurality of pixel electrodes 101 are disposed in the x direction, and the intervals at which a plurality of pixel electrodes 101 are disposed in the y direction cross each other. In addition, as shown in FIG. 15, the holding capacitor element 103 includes the upper electrode 103a, the lower electrode 103b, and the dielectric film 103c. In the holding capacitor elements 103, the lower electrode 103b, the dielectric film 103c, and the upper electrode 103a are formed in this order from the pixel switching element 102 side. In addition, the holding capacitor element 103 is formed so as to include the region facing the pixel switching element 102. The lower electrode 103b of the holding capacitor element 103 is connected to the second source/drain region 102b of the pixel switching element 102. In this embodiment, the holding capacitor element 103 is formed so as to be sandwiched between the pixel switching element 102 and the signal wiring 202 in the vertical direction z in the pixel region PR. More specifically, as shown in the form of a region R121 surrounded by a dotted line in FIG. 15, the lower electrode 103b of the holding capacitor element 103 is formed so as to face the region, other than the first source/drain region 102a, which includes the second source/drain region 102b in the pixel switching element 102 through only the insulating film 15 and the interlayer insulating film 16.

(Manufacturing Method)

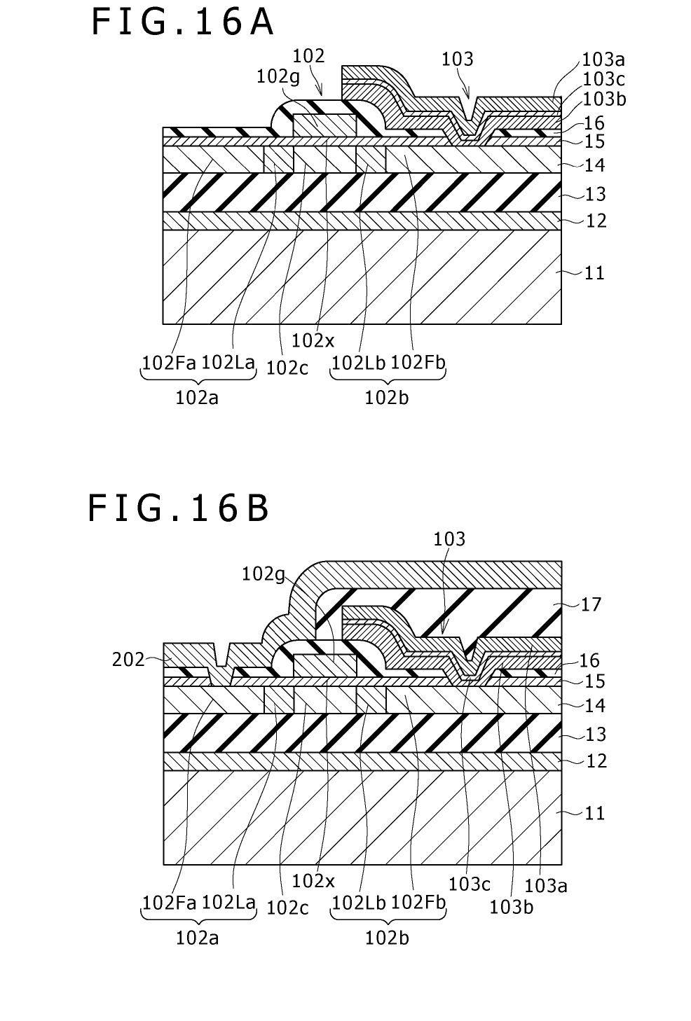

Hereinafter, a method of manufacturing the above-mentioned liquid crystal panel 1d in the liquid crystal display device of this embodiment will be described with reference to FIGS. 16A and 16B.

When the liquid crystal panel 1d described above is manufactured, the first impurity diffusion region 102Fa and the second impurity diffusion region 102Fb of the pixel switching element 102 are formed in the semiconductor layer 14 through the same processes as those in the third embodiment as shown in FIGS. 12A to 12C.

After that, the liquid crystal display device of this embodiment will be completed in the manner as will be described below.

FIGS. 16A and 16B are respectively cross sectional views showing processes for the array substrate 11 side in the liquid crystal display device according to the fourth embodiment of the present invention. In FIGS. 16A and 16B, the processes for the array substrate 11 side are shown in order of FIG. 16A and FIG. 16B.

After the processes described above are carried out, as shown in FIG. 16A, the holding capacitor element 103 is formed.

In this case, firstly, a silicon oxide is deposited by, for example, utilizing the CVD method, thereby forming the interlayer insulating film 16 so as to cover the pixel switching element 102. After that, a contact hole is formed in the interlayer insulating film 16 so as to expose the surface of the second impurity diffusion region 102Fb. Also, the lower electrode 103b, the dielectric film 103c, and the upper electrode 103a of the holding capacitor element 103 are formed in this order. In this embodiment, as described above, the lower electrode 103b of the holding capacitor element 103 is formed so as to face the region, other than the first source/drain region 102a, which includes the second source/drain region 102b of the pixel switching element 102 through only the insulating layer 15 and the interlayer insulating film 16.

Next, as shown in FIG. 16B, the signal wiring 202 is formed.

In this case, the interlayer insulating film 17 made of a silicon oxide is formed by, for example, utilizing the CVD method so as to cover the holding capacitor element 103. Also, the signal wiring 202 is formed similarly to the case of the first embodiment. After that, the portions of the liquid crystal panel id are formed similarly to the case of the first embodiment, thereby completing the liquid crystal display device.

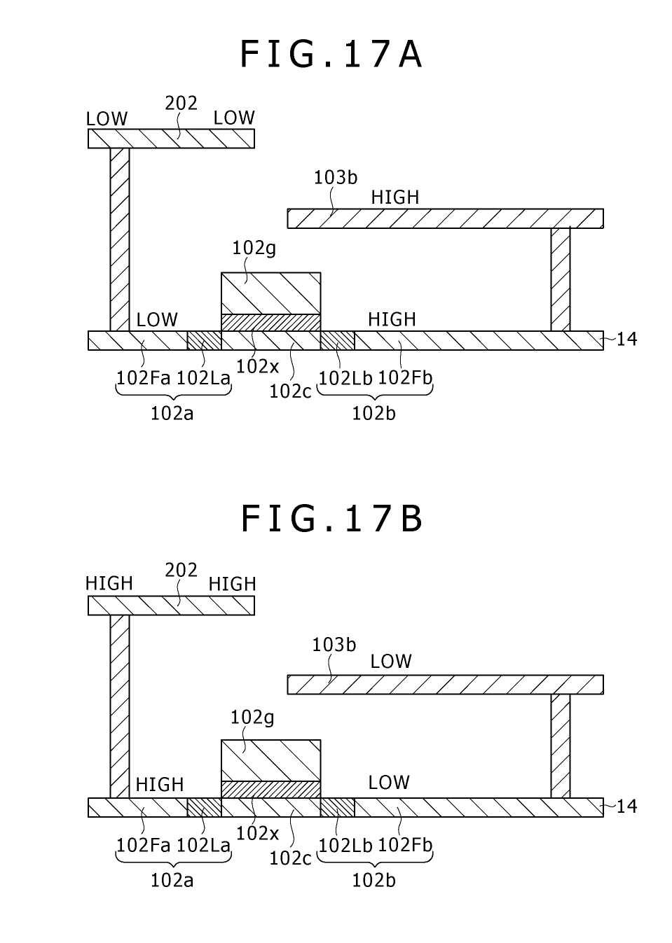

Hereinafter, an operation of the liquid crystal panel 1c in the liquid crystal display device of this embodiment will be described with reference to FIGS. 17A and 17B.

FIGS. 17A and 17B are respectively views each showing the potentials which are held in the respective portions of the liquid crystal panel 1d after the gate is turned OFF when the liquid crystal panel 1d is inversely driven in the fourth embodiment of the present invention. That is to say, FIG. 17A shows the case where the high potential is written to the pixel electrode, and FIG. 17B shows the case where the low potential is written to the pixel electrode.

As shown in FIG. 17A, while the pixel electrode 101 holds thereat the high potential HIGH, the second source/drain region 102b becoming the drain region in the pixel switching element 102, and the lower electrode 103b of the holding capacitor element 103 facing the second source/drain region 102b are connected to each other, and have the same potential.

On the other hand, as shown in FIG. 17B, while the pixel electrode 101 holds thereat the low potential LOW, the first source/drain region 102a becoming the drain region in the pixel switching element 102, and the signal wiring 202 facing the first source/drain region 102a are connected to each other, and are held at the same potential.

For this reason, in this embodiment, it is possible to suppress the occurrence of the leakage current in the phase of the OFF state. Also, the OFF-phase potential holding characteristics in the phase of the driving at the high potential HIGH can be equalized to that in the phase of the driving at the low potential LOW. Therefore, in this embodiment, when the pixel switching element 102 is formed on the surface of the array substrate 11 so as to face each of the conductive layers such as the signal wiring 202 and the holding capacitor element 103 in order to improve the aperture ratio of the pixel region PR, it is possible to prevent that the image holding characteristics are reduced due to the occurrence of the leakage current in the phase of the OFF state, and that the flicker and the residual image occur in the phase of the inverse driving. As a result, it is possible to improve the image quality.

It is noted that the members of this embodiment described above correspond to the constituent elements in the display device of the present invention, respectively, similarly to the case of the third embodiment.

### Fifth Embodiment

(Structure)

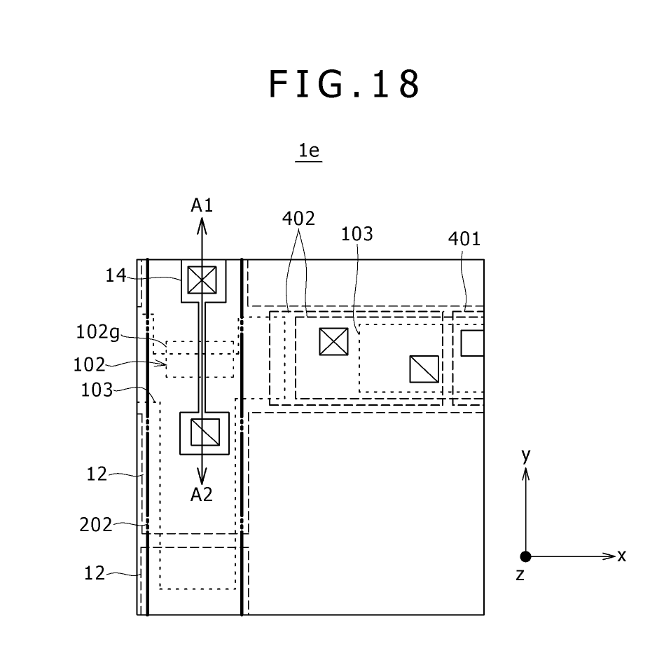

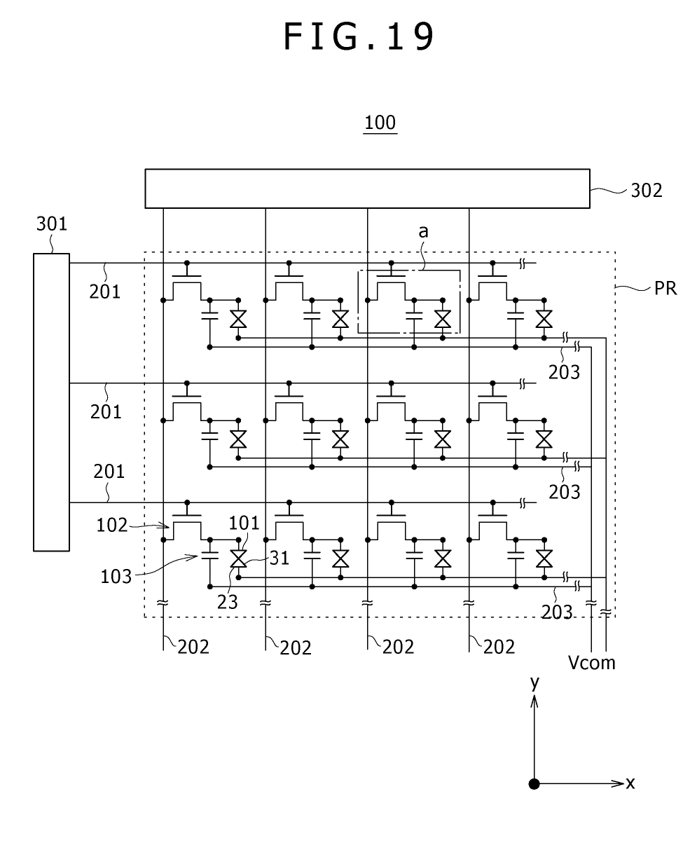

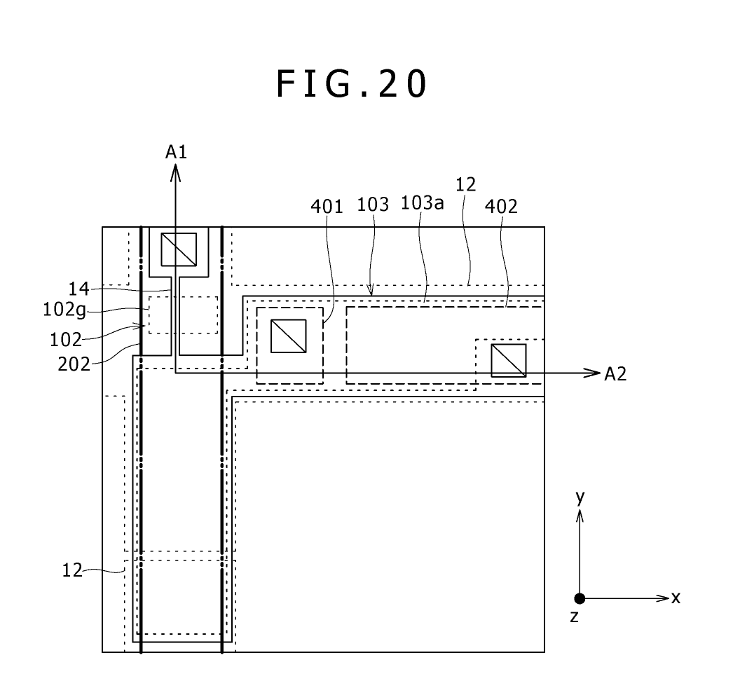

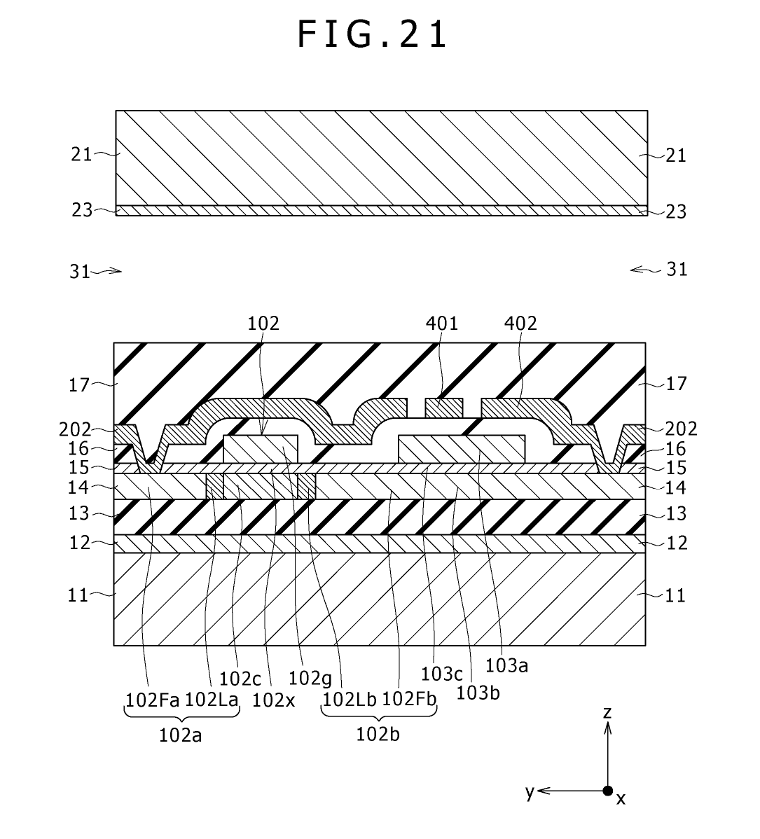

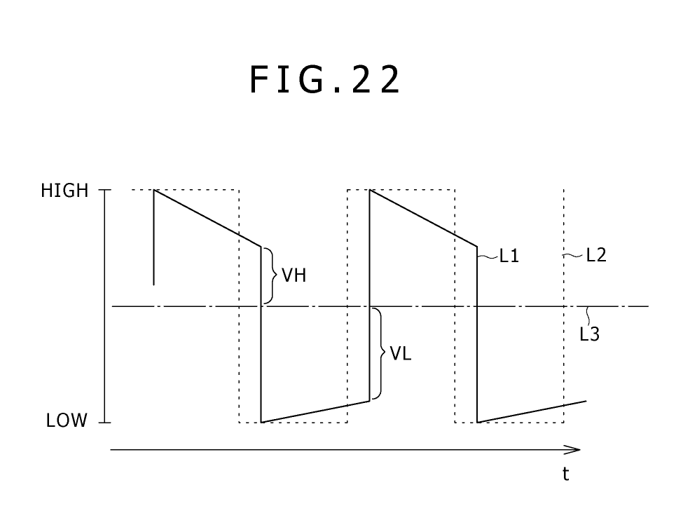

FIG. 18 is a plan view showing a part of a liquid crystal panel 1e in a liquid crystal display device according to a fifth embodiment of the present invention.

As shown in FIG. 18, the pixel switching element 102 and the holding capacitor element 103 of the liquid crystal panel 1e in the liquid crystal display device of the fifth embodiment are different from those of the liquid crystal panel 1d of the fourth embodiment. The constitution of this embodiment is approximately the same as that of the fourth embodiment except for this respect. Thus, the repeated portions are omitted here in the descriptions.

In this embodiment, as shown in FIG. 18, the pixel switching element 102 is formed so that a center of the gate electrode 102g corresponds to a center of a region where the scanning wiring 201 and the signal wiring 202 cross each other.

In addition, the lower electrode 103b of the holding capacitor element 103 faces the region, other than the first source/drain region 102a, which includes the second source/drain region 102b in the pixel switching element 102 through only the interlayer insulating film 16 similarly to the case of the fourth embodiment. For this reason, as shown in FIG. 18, the holding capacitor element 103 is formed so that its region corresponding to the pixel switching element 102 is different in shape from that in the fourth embodiment.

Therefore, in this embodiment, similarly to the case of the fourth embodiment, it is possible to prevent that due to the occurrence of the leakage current in the phase of the OFF state, the image holding characteristics are reduced, and the flicker and the residual image occur in the phase of the inverse driving. In addition thereto, it is possible to suppress that an outside light is made incident to the pixel switching element 102. Thus, the light can be prevented from leaking out. As a result, it is possible to enhance the image quality.

It is noted that the members of the liquid crystal panel 1e in the liquid crystal display device of this embodiment correspond to the constituent elements in the display device of the present invention, respectively, similarly to the case of the third embodiment.

In addition, when being implemented, the present invention is not intended to be limited to the embodiments described above, and the various changes can be adopted.

For example, in each of the embodiments, the TFT having the top gate structure is used as the pixel switching element 102. However, the TFT having a bottom gate structure may also be used as the pixel switching element 102.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a pixel electrode;
a pixel switching element having a first source/drain region and a second source/drain region formed to hold a channel formation region between them, and a gate electrode provided to correspond to said channel formation region through a gate insulating film;
a holding capacitor element having a first electrode and a second electrode formed to sandwich a dielectric film between them, said second electrode being connected to said second source/drain region;
a pixel electrode relay portion made of a conductive material, said pixel electrode and said second source/drain region being connected to each other through said pixel electrode relay portion; and
a signal wiring connected to said first source/drain region;
wherein said holding capacitor element is formed so that said dielectric film and said gate insulating film constitute the same layer, and said second electrode and said second source/drain region constitute the same layer,
said signal wiring extends at a predetermined interval from said first source/drain region so as to face each of said first source/drain region, said gate electrode and said second source/drain region,
said pixel electrode relay portion extends from said second source/drain region so as to face each of said gate electrode and said holding capacitor element between said signal wiring and each of said gate electrode and said second source/drain region, and
when a pixel potential is held through inverse driving, said signal wiring and said second source/drain region become different in potential from each other, and said pixel potential relay portion and said second source/drain region become equal in potential to each other.

2. A display device, comprising:
a pixel switching element having a first source/drain region and a second source/drain region formed to hold a channel formation region between them, and a gate electrode formed to correspond to said channel formation region through a gate insulating film;
a holding capacitor element having a first electrode and a second electrode formed to sandwich a dielectric film between them, said second electrode being connected to said second source/drain region;
a signal wiring connected to said first source/drain region; and
a signal wiring relay portion made of a conductive material, said signal wiring and said first source/drain region being connected to each other through said signal wiring relay portion;
wherein said signal wiring extends at a predetermined interval from each of said gate electrode and said second source/drain region so as to face each of them,
said signal wiring relay portion extends from said first source/drain region to said gate electrode between said first source/drain region and said signal wiring, said second electrode extends from said second source/drain region so as to face each of said second source/drain region and said first source/drain region through said signal wiring relay portion between said signal wiring and said signal wiring relay portion, and
when a pixel potential is held through inverse driving, said signal wiring and said second source/drain region become different in potential from each other, said second electrode and said first source/drain region become different in potential from each other, and said signal wiring relay portion and said first source/drain region become equal in potential to each other.
